(19) United States
(12) Patent Application Publication
(10) Pub. No.: US 2003/0096172 A1
(43) Pub. Date: May 22, 2003

(54) Hologram recording material composition and hologram recording medium

(76) Inventors: Taichi Ichihashi, Osaka-shi (JP); Hideo Tanigawa, Osaka-shi (JP); Yutaka Kamada, Osaka-shi (JP); Shoukichi Nakamura, Osaka-shi (JP); Takashi Matsuo, Osaka-shi (JP); Akira Hashimoto, Osaka-shi (JP); Takahiro Sakashita, Osaka-shi (JP); Kazunori Yokoyama, Osaka-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/975,560

(22) Filed: Oct. 12, 2001

Related U.S. Application Data
(63) Continuation-in-part of application No. 09/372,102, filed on Aug. 11, 1999, now abandoned.

(30) Foreign Application Priority Data
Aug. 12, 1998 (JP) 10-227818

(51) Int. Cl. G03H 1/04; G03C 1/73

(52) U.S. Cl. 430/1; 430/2; 359/3; 430/281.1

(57) ABSTRACT

A hologram recording material composition is disclosed, comprising (A) an allyl-based prepolymer having at least one allyl group in a molecule thereof, (B) a (meth)acrylate-based compound having at least one polymerizable unsaturated group in a molecule thereof, and (C) a photo-polymerization initiator, wherein a difference between a refractive index of said allyl-based prepolymer (A) and a refractive index of a polymer of said (meth)acrylate compound (B) is 0.005 or more.

### FIELD OF THE INVENTION

The present invention relates to a novel hologram recording material composition, and particularly a hologram recording material composition that can be easily formed into a film on production of a hologram recording medium and enables a recording medium being excellent in diffraction efficiency, which is one of fundamental characteristics required for a hologram, to be produced, and it also relates to the hologram recording medium obtained therefrom.

### BACKGROUND OF THE INVENTION

A hologram is a record of an interference pattern of coherent laser light on a photosensitive material, and is used in various field, such as an optical device, a three-dimensional display, interferometry and processing of an image and information, owing to the multi-functionality thereof.

As a representative example of the conventional hologram recording material composition, a gelatin dichromate photosensitive material and a breached silver salt photosensitive material (described, for example, in Display Holography Handbook, p. 66 to 67 (Gyoin Shokan, 1985) and Optical Engineering Handbook, p. 351 to 353 (Asakura Shoten, 1986)).

However, although gelatin dichromate has a high diffraction efficiency, and a silver salt photosensitive material has a high sensitivity, these materials require a complicated process on production of a hologram, and particularly they have a problem in that they require a wet development process.

As a photosensitive material to eliminate the problem, a hologram recording material composition containing a photo-polymerizable monomer is proposed. In this material, a photo-polymerizable monomer is polymerized in a portion having a large light amount in the interference pattern to cause a refractive index modulation in that portion, and thus a hologram is recorded. Examples thereof include a photo-polymerization type recording material mainly comprising cyclohexyl methacrylate and N-vinylcarbazole as photopolymerizable monomers; and a photo-polymerization initiator, and a photo-polymerization type recording material mainly comprising butyl methacrylate and ethylene glycol dimethacrylate as photopolymerizable monomers, and 1-phenylnaphthalene as an inert component not participating in the polymerization; and a photo-polymerization initiator (as described in Appl. Opt., vol. 15, p. 534 (1976)). However, because these materials are in a liquid state, the composition flows between two surface materials on recording a hologram to prevent recording in good conditions. Furthermore, a unreacted monomer remains after recording the hologram in a portion of a small light amount, and therefore the record is necessarily stabilized by conducting an exposure treatment on the whole surface.

JP-A-3-36582 and JP-A-3-249685 disclose a hologram recording material composition mainly comprising an allyl monomer and an acryl monomer that have different polymerization reactivities and different refractive indices of resulting polymers. Upon using the composition, a heat treatment is conducted after filling the composition between two surface materials to suppress the flowability of the composition, and thus the problems are to be solved.

However, the hologram recording material composition requires a heat treatment to be fixed between the two surface materials, and has a problem in that the process of film formation becomes complicated.

### SUMMARY OF THE INVENTION

An object of the invention is to provide a hologram recording material composition that can eliminate the problems associated with the conventional products, i.e., the complicated process of film formation, with exhibiting the excellent performance, such as transparency, diffraction efficiency and resolution, equivalent to the conventional products.

As a result of earnest investigations to attain the object described above by the inventors, a novel hologram recording material composition has been developed to complete the invention.

The invention relates to a hologram recording material composition comprising (A) an allyl-based prepolymer being soluble in a non-aqueous solvent and having at least one allyl group in a molecule thereof and a molecular weight of 10,000 to 100,000, (B) a (meth)acrylate-based compound having at least one polymerizable unsaturated group in a molecule thereof, and (C) a photo-polymerization initiator, wherein a difference between a refractive index of said allyl-based prepolymer (A) and a refractive index of a polymer of said (meth)acrylate compound (B) is 0.005 or more (preferably 0.01 or more).

The invention also relates to a hologram recording material composition comprising (A) an allyl-based prepolymer having at least one allyl group in a molecule thereof and a molecular weight of 10,000 to 100,000, (B) a (meth)acrylate-based compound having at least one polymerizable unsaturated group in a molecule thereof, (C) a photo-polymerization initiator, and a non-aqueous solvent, wherein a difference between a refractive index of said allyl-based prepolymer (A) and a refractive index of a polymer of said (meth)acrylate compound (B) is 0.005 or more (preferably 0.01 or more).

### DETAILED DESCRIPTION OF THE INVENTION

The allyl-based prepolymer (A) used in the invention is a prepolymer being soluble in organic solvents and insoluble in water and having at least one allyl group in its molecule, and representative examples thereof include a diallyl phthalate-based prepolymer. The allyl-based prepolymer (A) can be a homopolymer of an allyl-based monomer (a1) or a copolymer of the allyl-based monomer (a1) and the other copolymerizable monomer(s) (a2).

Examples of the allyl-based monomer (a1), namely an allyl compound and/or a methallyl compound (hereinafter referred to as “(meth)allyl compound”) are (meth)allyl alcohol, (meth)allyl chloride, (meth)allyl acetate, (meth)allyl benzoate, (meth)allyl isovalerate, (meth)allyl caprylate, (meth)allyl caproate, (meth)allyl formate, (meth)allyl cinnamate, (meth)allyl salicylate, (meth)allyl dihydrojasmonate, (meth)allyl phenylacetate, (meth)allyl propionate, (meth)allyl butyrate, mono(meth)allyl adipate, mono(meth)allyl sebacate, mono(meth)allyl phthalate, mono(meth)allyl isophthalate, mono(meth)allyl terephthalate, mono(meth)allyl succinate, mono(meth)allyl trimellitate, mono(meth)allyl succinate, mono(meth)allyl ricinolate, mono(meth)allyl maleate, di(meth)allyl adipate, di(meth)allyl sebacate, di(meth)allyl phthalate, di(meth)allyl isophthalate, di(meth)allyl terephthalate, di(meth)allyl succinate, di(meth)allyl trimellitate, di(meth)allyl succinate, di(meth)allyl ricinolate, di(meth)allyl maleate, tri(meth)allyl phosphate, tri(meth)allyl isocyanurate and the like.

Examples of the monomer (a2) which can copolymerize with the allyl-based monomer (a1) are styrene, α-methylstyrene, divinylbenzene, vinyl biphenylcarboxylate, mono(meth)acrylate such as benzyl methacrylate, phenoxyethyl methacrylate, phenoxyethyl acrylate, 2-hydroxy-3-phenoxypropyl acrylate, methyl methacrylate, ethyl methacrylate, n-butyl methacrylate, isobutyl methacrylate, 2-ethylhexyl methacrylate, isodecyl methacrylate, n-lauryl methacrylate, n-stearyl methacrylate, methoxydiethylene glycol methacrylate, cyclohexyl methacrylate, tetrahydrofurfuryl methacrylate, isobornyl methacrylate, 2-hydroxyethyl methacrylate, 2-hydroxypropyl methacrylate, 2-hydroxyethyl acrylate, 2-hydroxypropyl acrylate, 2-hydroxybutyl methacrylate, dimethylaminoethyl methacrylate, diethylaminoethyl methacrylate, glycidyl methacrylate, tert-butyl methacrylate, isostearyl methacrylate, n-butoxyethyl methacrylate, isoamyl acrylate, lauryl acrylate, stearyl acrylate, butoxyethyl acrylate, ethoxyethylene glycol acrylate, methoxytriethylene glycol acrylate, tetrahydrofurfuryl acrylate, isobornyl acrylate, 2-hydroxyethyl acrylate, 2-hydroxypropyl acrylate, 2-acryloyloxyethylsuccinic acid, 2-acryloyloxyethylphthalic acid, isooctyl acrylate, isomyristyl acrylate, isostearyl acrylate and vinyl acetate, and the like.

In the allyl-based prepolymer (A) which is the copolymer, a weight ratio of the allyl-based monomer (a1) to the copolymerizable monomer (a2), (a1):(a2) is 20 (excluding 20) to 100:80 to 0, preferably 30 (excluding 30) to 100:70 to 0, more preferably 40 to 100:60 to 0 expressed as percentage by weight.

The allyl-based prepolymer (A) is preferably a homopolymer of a diallyl phthalate-based monomer or a triallyl isocyanurate-based monomer, or a copolymer of another copolymerizable monomer and the monomer. More preferably, it is the homopolymer of the diallyl phthalate-based monomer or the copolymer of the copolymerizable monomer and the monomer. The most preferably, it is the homopolymer of the diallyl phthalate-based monomer.

There can also be suitably used a terpolymer of epichlorohydrin, ethylene oxide and allyl glycidyl ether, a terpolymer of diethylene glycol glycidyl methyl ether, ethylene oxide and allyl glycidyl ether, a terpolymer of 2-[1,3-bis(2-methoxyethoxyethoxy)propyl glycidyl ether, ethylene oxide and allyl glycidyl ether, and the like.

The diallylphthalate-based monomer as a starting material of the diallyl phthalate-based prepolymer is a compound selected from the group consisting of a diallylorthophthalate monomer, a diallylisophthalate monomer and diallylterephthalate monomer, and a combination of two or more of them. In order to obtain the diallyl phthalate-based prepolymer by homopolymerization of the diallyl phthalate-based monomer, the known polymerization reaction described, for example, in JP-B-35-16035 can be conducted. In order to obtain the diallylphthalate-based prepolymer by copolymerization of the diallylphthalate-based monomer, as the main component, with another monomer copolymerizable with the diallyl phthalate-based monomer, the known polymerization reaction described, for example, in Kogyo Kagaku Zasshi, vol. 70(3), p. 360 to 364 (1967) can be conducted.

In general, the copolymer mainly comprises a diallylphthalate constitutional unit.

As the allyl-based prepolymer (A) used in the invention, a homopolymer, such as a diallylorthophthalate prepolymer, e.g., “Daiso DAP” produced by Daiso Co., Ltd., a diallylisophthalate prepolymer, e.g., “ISO DAP” produced by Daiso Co., Ltd., and a diallylterephthalate prepolymer are preferred. The diallylterephthalate prepolymer can be, for example, a modified product thereof, e.g., “Daplen” produced by Daiso Co., Ltd. or “TAIC Prepolymer” produced by Nippon Kasei Chemical Co., Ltd. There can also be used the terpolymer of epichlorohydrin, ethylene oxide and allyl glycidyl ether, e.g., “Epichlomer CG Series” produced by Daiso Co., Ltd., the terpolymer of diethylene glycol glycidyl methyl ether, ethylene oxide and allyl glycidyl ether, the terpolymer of 2-[1,3-bis(2-methoxyethoxyethoxy)propyl glycidyl ether, ethylene oxide and allyl glycidyl ether (see JP-A-11-269263 and JP-A-11-345628), and the like.

Furthermore, the allyl-based prepolymer (A) can be an organic-inorganic complex transparent uniform material, which is a metallic oxide polymer obtained through dehydration condensation by a sol-gel method, for example, of a metallic alkoxide having a metallic atom, a group having an aromatic ring, and a hydrolyzable group as shown by the general formula below in the presence of a diallyl phthalate-based monomer and/or a diallyl phthalate-based polymer (see WO 99/14274).

The metallic alkoxide is a substance represented by the general formula:

XₘM(Ar)ₙR²ₚ

wherein X represents an alkoxy group represented by the general formula R¹O (wherein R¹ represents a monovalent organic group); M represents a metallic atom selected from the group consisting of silicon, titanium, zirconium germanium and aluminum; Ar represents a group having an aromatic ring; R² represents a monovalent organic group; m and n are a number of 1 or more; and p is a number of 0 or more, provided that m+n+p is the valence number of the metallic atom represented by M.

Specific examples of a metallic alkoxide having a tetravalent metallic atom (e.g., Si, Ti, Zr and Ge) include the following; (CH₃O)₃MPh, (C₂H₅O)₃M(CH₂Ph), (C₂H₃O)₃M(C₂H₄OPh), (C₃H₈NO)₃MPh, (C₄H₉O)₃M(C₃H₄Ph), (CH₄NO)₂MPh₂, (C₂H₅O)₂M(CH₃MPh)₂, (C₃H₅O)₂M(C₄H₈Ph)₂, (C₄H₁₀NO)₂M(C₂H₂O₂Ph)₂, (CH₃O)₂M(C₄H₉NPh)(C₄H₉), (C₂H₅O)₂M(C₄H₆O₂Ph)(C₃H₅), (C₂H₃O)₂M(C₂H₄Ph)(C₂H₅O), (C₃H₈NO)₂M(CH₂Ph)(CH₄N), (C₄H₉O)₂MPh(CH₃), (CH₄NO)₂MPh(C₂H₅), (C₂H₅O)₂M(CH₂Ph) (C₃H₇O), (C₃H₅O)₂M(C₂H₂Ph)(C₅H₉O₂), (C₄H₁₀NO)₂MPh(C₄H₁₀N), (CH₃O)₂M(CH₂OPh)(C₃H₇), (C₂H₅O)₂M(C₅H₈O₂Ph)(C₄H₉), (C₂H₃O)₂MPh(C₃H₈N), (C₃H₈NO)₂M(C₂H₄Ph)(C₂H₅), (C₄H₉O)₂MPh(C₂H₃O₂), (CH₄NO)₂MPh(C₃H₇), (C₂H₅O)₂M(CH₃NPh)(C₃H₅O₂), (C₃H₅O)₂M(C₄H₈Ph)(C₂H₃) and (C₄H₁₀NO)₂M(C₂H₂O₂Ph)(CH₃).

Preferred examples of metallic alkoxide are phenylalkoxysilane such as (CH₃O)₃MPh, (C₂H₅O)₃MPh, (C₃H₇O)₃MPh, (C₄H₉O)₃MPh, (CH₃O)₂MPh₂, (C₂H₅O)₂MPh₂, (C₃H₇O)₂MPh₂ or (C₄H₉O)₂MPh₂ and phenyltrimethoxysilane is the most preferable among them.

Preferred examples of Aluminum alkoxide include the following. (CH₃O)₂AlPh, (C₂H₅O)₂AlPh, (C₃H₇O)₂AlPh, (C₄H₉O)₂AlPh, (CH₃O)AlPh₂, (C₂H₅O)AlPh₂, (C₃H₇O)AlPh₂, (C₄H₉O)AlPh₂.

The allyl-based prepolymer (A) can have a thioether group and/or a halogen atom connected to the main chain thereof. The introduction of a thioether group and/or a halogen atom is conducted by a method where a thiol compound and/or a halogen is added to a polymerization system of an allyl-based monomer, or a method where a thiol compound and/or a halogen are subjected to an addition reaction with the allyl-based prepolymer (A). Examples of the thiol compound used for the introduction of a thioether group include a thiophenol-based compound, such as thiophenol, 2-chlorothiophenol, 4-chlorothiophenol, 4-tert-butylthiophenol and 4-mercaptophenol; dithiol-based compound such as 4,4′-thiodibenzenethiol; aliphatic thiol compound such as n-butylmercaptan and n-laurylmercaptan. Examples of the halogen used for the introduction of an halogen atom include bromine and chlorine.

Examples of each of the homopolymer or copolymer of an allyl-based monomer, the organic-inorganic complex transparent material, and the allyl-based prepolymer containing a thioether group (or a halogen atom) can be used singly or in combination of two or more of them. Furthermore, the homopolymer or copolymer of an allyl-based monomer can be used in combination with the organic-inorganic complex transparent material and/or the allyl-based prepolymer containing a thioether group (or a halogen atom).

It is particularly preferred that the diallylphthalate-based prepolymer is a prepolymer that can be subjected to post-polymerization having a softening temperature of from 50 to 110° C., an iodine value measured by the Wijs method of from 50 to 95, a viscosity as a methyl ethyl ketone 50% solution (30° C.) of from 50 to 300 cp, and an average molecular weight of polystyrene conversion measure by the GPC (gel permeation chromatography) method of from 10,000 to 100,000, and preferably from 30,000 to 60,000.

The hologram recording material composition of the invention can further contain a solvent-soluble thermoplastic resin (D) in addition to the allyl-based prepolymer (A), the (meth)acrylate-based compound (B) and the photo-polymerization initiator (C). The weight proportion of the thermoplastic resin (D), in terms of a weight ratio to the allyl-based prepolymer (A), (A):(D) is from 80:20 to 100:0, and preferably from 85:15 to 100:0. The thermoplastic resin (D) is selected in such a manner that a difference between the refractive index of the polymer of the (meth)acrylate-based compound (B) and the weighted mean of those of the allyl-based prepolymer (A) and the thermoplastic resin (D) is 0.01 or more. As the solvent-soluble thermoplastic resin (D), those having a refractive index of from 1.300 to 1.800 are preferably used in the present invention. Specific examples thereof include a condensation polymerization product of a diphenol compound and a dicarboxylic acid compound, a resin having a carbonate group in the molecule, a resin having an —SO₂— group in the molecule, polyvinylidene chloride, and a homopolymer or copolymer obtained by polymerizing at least one monomer having an ethylenic unsaturated double bond. These polymers can be used singly or in combination of two or more thereof.

Examples of the condensation polymerization product of a diphenol compound and a dicarboxylic acid compound include polyarylate. Examples of the resin having a carbonate group in the molecule include polycarbonate. Examples of the resin having an —SO₂— group in the molecule include polysulfone and polyether sulfone. Examples of the homopolymer or copolymer obtained by polymerizing a monomer having an ethylenic unsaturated double bond include polystyrene, polymethyl methacrylate, an ethylene-vinyl acetate copolymer, polymethylpentene, a cyclic olefin polymer, and a copolymer of a cyclic olefin and ethylene.

In order to obtain a high diffraction efficiency, polyarylate, polycarbonate and polysulfone are preferably used.

The (meth)acrylate-based compound (B) used in the invention is a compound having at least one polymerizable unsaturated group, such as a (meth)acryl group, in the molecule, and is a compound obtained by esterification of (meth)acrylic acid with a monovalent or polyvalent alcohol, and an oligomer, such as a dimer and a trimer, thereof. The (meth)acrylate-based compound (B) can be fluorene (meth)acrylate. In general, a polymer of the (meth)acrylate-based compound (B) has a refractive index smaller than that of the allyl-based prepolymer (A), provided that a polymer of fluorene (meth)acrylate has a refractive index larger than the refractive index of the allyl-based prepolymer (A). The (meth)acrylate-based compound (B) has at least one, preferably from 1 to 6, (the most preferably two) polymerizable unsaturated group in the molecule. The (meth)acrylate-based compound (B) has a molecular weight of preferably 2,000 or less, and more preferably 1,500 or less. The (meth)acrylate-based compound (B) is selected depending on the extent of the refractive index modulation and the usage of the resulting hologram.

The (meth)acrylate-based compound (B) can comprise from 10 to 100% by weight of at least one radical polymerizable compound (b1) selected from the group consisting of a fluorene-based compound [I], a sulfide-based cyclic compound [II], a halogenated cyclic compound [III] and a carbazole-based compound [IV] mentioned later.

(Meth)acrylate-based compound (B) are exemplified as follows.

Examples of mono(meth)acrylate include the following. Methyl methacrylate, ethyl methacrylate, n-butyl methacrylate, isobutyl methacrylate, 2-ethylhexyl methacrylate, isodecyl methacrylate, n-lauryl methacrylate, n-stearyl methacrylate, methoxydiethylene glycol methacrylate, cyclohexyl methacrylate, tetrahydrofurfuryl methacrylate, benzyl methacrylate, phenoxyethyl methacrylate, isobornyl methacrylate, 2-hydroxyethyl methacrylate, 2-hydroxypropyl methacrylate, 2-hydroxyethyl acrylate, 2-hydroxypropyl acrylate, 2-hydroxybutyl methacrylate, dimethylaminoethyl methacrylate, diethylaminoethyl methacrylate, glycidyl methacrylate, tert-butyl methacrylate, isostearyl methacrylate, n-butoxyethyl methacrylate, isoamyl acrylate, lauryl acrylate, stearyl acrylate, butoxyethyl acrylate, ethoxyethylene glycol acrylate, methoxytriethylene glycol acrylate, phenoxyethyl acrylate, tetrahydrofurfuryl acrylate, isobornyl acrylate, 2-hydroxyethyl acrylate, 2-hydroxypropyl acrylate, 2-hydroxy-3-phenoxypropyl acrylate, 2-acryloyloxyethylsuccinic acid, 2- acryloyloxyethylphthalic acid, isooctyl acrylate, isomyristyl acrylate, isostearyl acrylate.

Examples of di(meth)acrylate include the following. Ethylene glycol dimethacrylate, diethylene glycol dimethacrylate, triethylene glycol dimethacrylate, tetraethylene glycol dimethacrylate, nonaethylene glycol diacrylate, 1,4-butanediol dimethacrylate, 1,6-hexanediol dimethacrylate, 1,9-nonanediol dimethacrylate, glycerin dimethacrylate, 2-hydroxy-3-acryloyloxypropyl methacrylate, neopentyl glycol dimethacrylate, 1,3-butanediol dimethacrylate, 1,10-decanediol dimethacrylate, ethylene glycol diacrylate, diethylene glycol diacrylate, triethylene glycol diacrylate, tetraethylene glycol diacrylate, 1,4-butanediol diacrylate, 1,6-hexanediol diacrylate, 1,9-nonanediol diacrylate, glycerin diacrylate, 2-hydroxy-3-acryloyloxypropyl acrylate, neopentyl glycol diacrylate, 1,3-butanediol diacrylate, 1,10-decanediol diacrylate.

Examples of tri(meth)acrylate include the following. Trimethylolpropane trimethacrylate, pentaerythritol trimethacrylate, trimethylolpropane triacrylate, pentaerythritol triacrylate.

Examples of tetra(meth)acrylate include the following. Pentaerythritol tetramethacrylate, pentaerythritol tetraacrylate, ditrimethylolpropane tetramethacrylate, ditrimethylolpropane tetraacrylate, tetramethylolmethane tetraacrylate, etc.

Examples of hexa(meth)acrylate include the following. Dipentaerythritol hexamethacrylate, dipentaerythritol hexaacrylate, etc.

Preferred oligomer is a dimer or trimer of a compound obtained by esterification of (meth)acrylic acid with a monovalent or polyvalent alcohol.

Examples of aromatic compounds are styrene, 2-chlorostyrene, 2-bromostyrene, vinyltoluene, divinylbenzene, 2-vinylbiphenyl, 3-vinylbiphenyl, 4-vinylbiphenyl, divinylbiphenyl, 4,4′-divinylbiphenyl, vinylnaphthalene, divinylnaphthalene, 2,2-bis[3,5-dibromo-4-(2-methacryloyloxyethoxy)phenyl]propane, 2,2-bis[3,5-dibromo-4-(2-acryloyloxyethoxy)phenyl]propane, phenyl (meth)acrylate, 2-phenylethyl (meth)acrylate, 2-phenoxyethyl (meth)acrylate, phenolethoxylate mono(meth)acrylate, p-chlorophenyl (meth)acrylate, 2-(p-chlorophenoxy)ethyl (meth)acrylate, p-bromophenyl (meth)acrylate, 2-(p-bromophenoxy)ethyl (meth)acrylate, 1,4-benzenediol di(meth)acrylate, 1,3,5-triisopropenylbenzene, 2-(1-naphthyloxy)ethyl (meth)acrylate, ethoxylate bisphenol A di(meth)acrylate, bisphenol A di(2-(meth)acryloxyethyl) ether and the like.

These examples can be used singly or in combination of two or more of them.

Preferred (meth)acrylate-based compounds (B) are di(meth)acrylate-based compounds. Particularly preferred compounds are ethylene glycol dimethacrylate, neopentyl glycol diacrylate, nonaethylene glycol dimethacrylate, polyethylene glycol dimethacrylate (n=14) and 9,9-bis(4-(2-acryloyloxyethoxy)phenyl)fluorene.

The radical polymerizable compound (b1) is described hereinafter.

The fluorene-based compound is represented by the general formula [I],

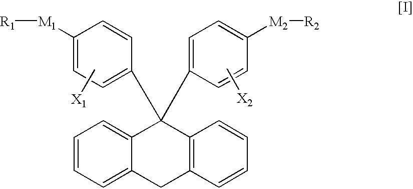

wherein R₁ and R₂, being the same or different, are monovalent organic groups at least one of which has a radical polymerizable group at its terminal, M₁ and M₂, being the same or different, are divalent organic groups represented by —(OR)ₙ₁— (wherein R is lower alkylene which can have hydroxyl and/or oxygen, and n1 is 0 or an integer of 1 to 5) or single bonds, and X₁ and X₂, being the same or different, are substituents of the rings and are halogen, hydroxyl or lower alkyl.

The sulfide-based cyclic compound is represented by the general formula [II],

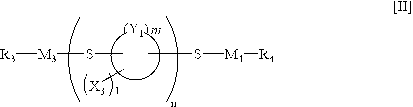

wherein R₃ and R₄, being the same or different, are monovalent organic groups, at least one of which has a radical polymerizable group at its terminal, M₃ and M_{4,} being the same or different, are divalent organic groups represented by —(OR)ₙ₂— (wherein R is lower alkylene which can have hydroxyl and/or oxygen, and n2 is 0 or an integer of 1 to 5) or single bonds, X₃ is a substituent of the ring and is halogen, hydroxyl or lower alkyl, “l” is an X₃ number of 0 to 6, Y₁ is a ring member atom constituting the ring, all of the atoms (Y₁)ₘ are carbon atoms, or a portion of them is carbon atom(s) and the rest atoms are heteroatoms, and “m” is a member number of the ring of 5 to 8,

The halogenated cyclic compound is represented by the general formula [III ],

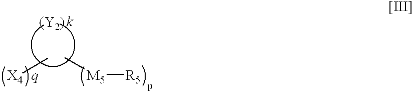

wherein X₄ is a substituent of the ring, at least one of plural (X₄)_{q} is halogen and others are hydroxyl or lower alkyl, “q” is an integer of 2 to 6, R₅ is a monovalent organic group, at least one of plural (R₅)ₚ has a radical polymerizable group at its terminal, M₅ is a divalent organic group represented by —(OR)ₙ₃— (wherein R is lower alkylene which can have hydroxyl and/or oxygen, and n3 is 0 or an integer of 1 to 5) or a single bond, “p” is an integer of 1 to 4, Y₂ is a ring member atom constituting the ring, all of the atoms (Y₂)ₖ are carbon atoms, or a portion of them is carbon atom(s) and the rest atoms are heteroatoms, and “k” is a member number of the ring of 5 to 8.

The carbazole-based compound is represented by the general formula [IV],

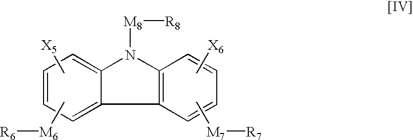

wherein R₆, R₇ and R₈, being the same or different, are monovalent organic groups, at least one of which has a radical polymerizable group at its terminal, M₆, M₇ and M₈, being the same or different, are divalent organic groups represented by —(OR)ₙ₄— (wherein R is lower alkylene which can have hydroxyl and/or oxygen, and n4 is 0 or an integer of 1 to 5) or single bonds, and X₅ and X₆, being the same or different, are substituents of the ring and are halogen, hydroxyl or lower alkyl.

The fluorene-based compound [I] is as follows among radical polymerizable compound (b1).

In the general formula [I] of the fluorene-based compound, in the organic groups R₁ and R₂, the radical polymerizable group can be a functional group such as vinyl, (meth)acryloyl or (meth)acryloyloxy. The organic groups R₁ and R₂ having no radical polymerizable group can be lower alkyl having one to five carbon atoms.

In —(OR)ₙ₁— of M₁ and M₂, a carbon number of the lower alkylene R is preferably one to five, more preferably one to three. Examples of OR are oxymethylene, oxyethylene, oxypropylene, oxybutylene and the like. Examples of (OR)ₙ₁ (n1 is an integer of 2 to 5) are dioxymethylene, dioxyethylene, dioxypropylene, dioxybutylene, trioxymethylene, trioxyethylene, trioxypropylene, trioxybutylene, tetraoxymethylene, tetraoxyethylene, tetraoxypropylene, tetraoxybutylene and the like. When the lower alkylene R has hydroxyl, the hydroxyl can exist at any positions of the alkylene, and an example of the alkylene having hydroxyl is (2-hydroxy)propylene.

The organic groups X₁ and X₂ can be alkyl having one to five carbon atoms such as methyl, ethyl or propyl.

The fluorene-based compound [I] is exemplified hereinafter. Examples of fluorene-based (meth)acrylate are 9,9-bis(4-(meth)acryloyloxyphenyl)fluorene, 9,9-bis(4-(meth)acryloyloxymethoxyphenyl)fluorene, 9,9-bis(4-(2-(meth)acryloyloxyethoxy)phenyl)fluorene, 9,9-bis(4-(2-(meth)acryloyloxypropoxy)phenyl)fluorene, 9,9-bis(4-(3-(meth)acryloyloxypropoxy)phenyl)fluorene, 9,9-bis(4-(meth)acryloyloxydimethoxyphenyl)fluorene, 9,9-bis(4-(meth)acryloyloxydiethoxyphenyl)fluorene, 9,9-bis(4-(meth)acryloyloxydipropoxyphenyl)fluorene, 9,9-bis(4-(meth)acryloyloxytrimethoxyphenyl)fluorene, 9,9-bis(4-(meth)acryloyloxytriethoxyphenyl)fluorene, 9,9-bis(4-(meth)acryloyloxytripropoxyphenyl)fluorene, 9,9-bis(4-(meth)acryloyloxytetramethoxyphenyl)fluorene, 9,9-bis(4-(meth)acryloyloxytetraethoxyphenyl)fluorene, 9,9-bis(4-(meth)acryloyloxytetrapropoxyphenyl)fluorene, 9,9-bis(4-(meth)acryloyloxy-3-methylphenyl)fluorene, 9,9-bis(4-(meth)acryloyloxymethoxy-3-methylphenyl)fluorene, 9,9-bis(4-(2-(meth)acryloyloxyethoxy)-3-methylphenyl)fluorene, 9,9-bis(4-(2-(meth)acryloyloxypropoxy)-3-methylphenyl)fluorene, 9,9-bis(4-(3-(meth)acryloyloxypropoxy)-3-methylphenyl)fluorene, 9,9-bis(4-(meth)acryloyloxydimethoxy-3-methylphenyl)fluorene, 9,9-bis(4-(meth)acryloyloxydiethoxy-3-methylphenyl)fluorene, 9,9-bis(4-(meth)acryloyloxydipropoxy-3-methylphenyl)fluorene, 9,9-bis(4-(meth)acryloyloxytrimethoxy-3-methylphenyl)fluorene, 9,9-bis(4-(meth)acryloyloxytriethoxy-3-methylphenyl)fluorene, 9,9-bis(4-(meth)acryloyloxytripropoxy-3-methylphenyl)fluorene, 9,9-bis(4-(meth)acryloyloxytetramethoxy-3-methylphenyl)fluorene, 9,9-bis(4-(meth)acryloyloxytetraethoxy-3-methylphenyl)fluorene, 9,9-bis(4-(meth)acryloyloxytetrapropoxy-3-methylphenyl)fluorene, 9,9-bis(4-(meth)acryloyloxy-3-ethylphenyl)fluorene, 9,9-bis(4-(meth)acryloyloxymethoxy-3-ethylphenyl)fluorene, 9,9-bis(4-(2-(meth)acryloyloxyethoxy)-3-ethylphenyl)fluorene, 9,9-bis(4-(2-(meth)acryloyloxypropoxy)-3-ethylphenyl)fluorene, 9,9-bis(4-(3-(meth)acryloyloxypropoxy)-3-ethylphenyl)fluorene, 9,9-bis(4-(meth)acryloyloxydimethoxy-3-ethylphenyl)fluorene, 9,9-bis(4-(meth)acryloyloxydiethoxy-3-ethylphenyl)fluorene, 9,9-bis(4-(meth)acryloyloxydipropoxy-3-ethylphenyl)fluorene, 9,9-bis(4-(meth)acryloyloxytrimethoxy-3-ethylphenyl)fluorene, 9,9-bis(4-(meth)acryloyloxytriethoxy-3-ethylphenyl)fluorene, 9,9-bis(4-(meth)acryloyloxytripropoxy-3-ethylphenyl)fluorene, 9,9-bis(4-(meth)acryloyloxytetramethoxy-3-ethylphenyl)fluorene, 9,9-bis(4-(meth)acryloyloxytetraethoxy-3-ethylphenyl)fluorene, 9,9-bis(4-(meth)acryloyloxytetrapropoxy-3-ethylphenyl)fluorene, 9,9-bis(4-(meth)acryloyloxy-3-propylphenyl)fluorene, 9,9-bis(4-(meth)acryloyloxymethoxy-3-propylphenyl)fluorene, 9,9-bis(4-(2-(meth)acryloyloxyethoxy)-3-propylphenyl)fluorene, 9,9-bis(4-(2-(meth)acryloyloxypropoxy)-3-propylphenyl)fluorene, 9,9-bis(4-(3-(meth)acryloyloxypropoxy)-3-propylphenyl)fluorene, 9,9-bis(4-(meth)acryloyloxydimethoxy-3-propylphenyl)fluorene, 9,9-bis(4-(meth)acryloyloxydiethoxy-3-propylphenyl)fluorene, 9,9-bis(4-(meth)acryloyloxydipropoxy-3-propylphenyl)fluorene, 9,9-bis(4-(meth)acryloyloxytrimethoxy-3-propylphenyl)fluorene, 9,9-bis(4-(meth)acryloyloxytriethoxy-3-propylphenyl)fluorene, 9,9-bis(4-(meth)acryloyloxytipropoxy-3-propylphenyl)fluorene, 9,9-bis(4-(meth)acryloyloxytetramethoxy-3-propylpenyl)fluorene, 9,9-bis(4-(meth)acryloyloxytetraethoxy-3-propylphenyl)fluorene, 9,9-bis(4-(meth)acryloyloxytetrapropoxy-3-propylphenyl)fluorene, 9,9-bis(4-(meth)acryloyloxy-(2-hydroxy)propoxyphenyl)fluorene, 9,9-bis(4-(meth)acryloyloxy-(2-hydroxy)propoxy-3-methylphenyl)fluorene, 9,9-bis(4-(meth)acryloyloxy-(2-hydroxy)propoxyethoxyphenyl)fluorene, bisphenolfluorene dihydroxyacrylate, namely an acrylic acid adduct of 9,9-bis(4-hydroxyphenyl)fluorene glycidyl ether (produced by Nippon Steel Chemical Co., Ltd.), bisphenolfluorene dimethacrylate (produced by Nippon Steel Chemical Co., Ltd.), bisphenoxyethanolfluorene diacrylate (BPEF-A produced by Osaka Gas Co., Ltd.), bisphenoxyethanolfluorene dimethacrylate (BPEF-MA produced by Osaka Gas Co., Ltd.), bisphenoxyethanolfluorene diepoxyacrylate (BPEF-GA produced by Osaka Gas Co., Ltd.), bisphenolfluorene diepoxyacrylate (BPF-GA produced by Osaka Gas Co., Ltd.), biscresolfluorene diepoxyacrylate (BCF-GA produced by Osaka Gas Co., Ltd.) and the like.

Particularly preferred fluorene compounds are bisphenolfluorene dihydroxyacrylate, namely an acrylic acid adduct of 9,9-bis(4-hydroxyphenyl)fluorene glycidyl ether (produced by Nippon Steel Chemical Co., Ltd.), bisphenolfluorene dimethacrylate (produced by Nippon Steel Chemical Co., Ltd.), bisphenoxyethanolfluorene diacrylate (BPEF-A produced by Osaka Gas Co., Ltd.), bisphenoxyethanolfluorene dimethacrylate (BPEF-MA produced by Osaka Gas Co., Ltd.), bisphenoxyethanolfluorene diepoxyacrylate (BPEF-GA produced by Osaka Gas Co., Ltd.), bisphenolfluorene diepoxyacrylate (BPF-GA produced by Osaka Gas Co., Ltd.), biscresolfluorene diepoxyacrylate (BCF-GA produced by Osaka Gas Co., Ltd.) and the like.

The fluorene-based compound can be an oligomer such as a dimer or a trimer of the above-mentioned compound.

These exemplified compounds can be used solely or in combination.

Next, the sulfide-based cyclic compound [II] is described.

In the general formula [II] of the sulfide-based cyclic compound, the circle represents cyclic structure, Y₁ is a ring member atom constituting the ring, and “m” is the number of the constituent atom Y₁ of the ring, namely the member number of the ring. “m” is preferably 5 to 8, more preferably 5 or 6, the most preferably 6. The plural atoms (Y₁)ₘ can be all carbon atoms (in this case, the ring is a carbon ring), or a portion of the plural atoms (Y₁)ₘ can be heteroatom(s) such as sulfur atom(s), nitrogen atom(s) and/or oxygen atom(s) and the rest atoms can be carbon atoms (in this case, the ring is a heterocycle). The ring can be saturated or unsaturated, and the ring preferably has unsaturated bond(s). “n” is preferably 1 to 5, more preferably 1 to 3, the most preferably 2 or 3. X₃, is a substituent of the ring and is halogen, hydroxyl or lower alkyl. The X₃ number “l” is preferably 0 to 6, more preferably 0 to 4, the most preferably 0 to 2.

In the organic groups R₃ and R₄, the radical polymerizable group can be a functional group such as vinyl, (meth)acryloyl or (meth)acryloyloxy. The organic groups R₃ and R₄ having no radical polymerizable group can be lower alkyl having one to five carbon atoms. The heteroatom(s) can be nitrogen atom(s), oxygen atom(s) and/or sulfur atom(s).

In —(OR)ₙ₂— of M₃ and M₄, a carbon number of the lower alkylene R is preferably one to five, more preferably one to three. Examples of OR are oxymethylene, oxyethylene, oxypropylene, oxybutylene and the like. Examples of (OR)ₙ₂ (n2 is an integer of 2 to 5) are dioxymethylene, dioxyethylene, dioxypropylene, dioxybutylene, trioxymethylene, trioxyethylene, trioxypropylene, trioxybutylene, tetraoxymethylene, tetraoxyethylene, tetraoxypropylene, tetraoxybutylene and the like. When the lower alkylene R has hydroxyl, the hydroxyl can exist at any positions of the alkylene, and an example of the alkylene having hydroxyl is (2-hydroxy)propylene.

The sulfide-based cyclic compound [II] is exemplified hereinafter.

Symmetric compounds having functional groups (acryl, methacryl, vinyl) at the 2nd-, 3rd-, 4th-position of the phenyl ring: bis(2-(meth)acryloylthiophenyl)sulfide, bis(2-vinylthiophenyl)sulfide, bis(3-(meth)acryloylthiophenyl)sulfide, bis(3-vinylthiophenyl)sulfide, bis(4-(meth)acryloylthiophenyl)sulfide and bis(4-vinylthiophenyl)sulfide, Asymmetric compounds having functional groups (acryl, methacryl, vinyl) at the 2nd-, 3rd-, 4th-position of the phenyl ring: 2-(meth)acryloylthiophenyl-3′-(meth)acryloylthiophenylsulfide, 2-(meth)acryloylthiophenyl-4′-(meth)acryloylthiophenylsulfide, 3-(meth)acryloylthiophenyl-4′-(meth)acryloylthiophenylsulfide, 2-vinylthiophenyl-3′-vinylthiophenylsulfide, 2-vinylthiophenyl-4′-vinylthiophenylsulfide, 3-vinylthiophenyl-4′-vinylthiophenylsulfide, 2-(meth)acryloylthiophenyl-3′-vinylthiophenylsulfide, 2-(meth)acryloylthiophenyl-4′-vinylthiophenylsulfide and 3-(meth)acryloylthiophenyl-4′-vinylthiophenylsulfide.

Compounds having functional groups (acryl, methacryl, vinyl) and substituents (halogen, lower alkyl, hydroxyl) at the 2nd-, 3rd-, 4th-position of the phenyl ring: bis(3-bromo-2-(meth)acryloylthiophenyl)sulfide, bis(4-chloro-2-(meth)acryloylthiophenyl)sulfide, bis(3-hydroxy-2-vinylthiophenyl)sulfide, bis(2-methyl-3-(meth)acryloylthiophenyl)sulfide, bis(4-propyl-3-(meth)acryloylthiophenyl)sulfide, bis(2-ethyl-3-vinylthiophenyl)sulfide, bis(2-butyl-4-(meth)acryloylthiophenyl)sulfide, bis(3-pentyl-4-(meth)acryloylthiophenyl)sulfide, bis(2-hydroxy-4-vinylthiophenyl)sulfide, 3-bromo-2-(meth)acryloylthiophenyl-3′-(meth)acryloylthiophenylsulfide, 3-ethyl-2-(meth)acryloylthiophenyl-4′-(meth)acryloylthiophenylsulfide, 2-hydroxy-3-(meth)acryloylthiophenyl-4′-(meth)acryloylthiophenylsulfide, 3-bromo-2-(meth)acryloylthiophenyl-2′-butyl-3′-(meth)acryloylthiophenyl-sulfide, 3-ethyl-2-(meth)acryloylthiophenyl-3′-hydroxy-4′-(meth)acryloyl-thiophenylsulfide, 2-hydroxy-3-(meth) acryloylthiophenyl-2′-chloro-4′-(meth)acryloylthiophenylsulfide, 3-bromo-2-vinylthiophenyl-2′-butyl-3′-vinylthiophenylsulfide, 3-ethyl-2-vinylthiophenyl-3′-hydroxy-4′-vinylthiophenylsulfide, 2-hydroxy-3-vinylthiophenyl-2′-chloro-4′-vinylthiophenylsulfide, 3-bromo-2-(meth)acryloylthiophenyl-2′-butyl-3′-(meth)acryloylthiophenylsulfide, 3-ethyl-2-(meth)acryloylthiophenyl-3′-hydroxy-4′-(meth)acryloylthiophenylsulfide, 2-hydroxy-3-(meth)acryloyl-thiophenyl-2′-chloro-4′-(meth)acryloylthiophenylsulfide, 3-bromo-2-(meth)acryloylthiophenyl-2′-butyl-3′-vinylthiophenylsulfide, 3-ethyl-2-(meth)acryloylthiophenyl-3′-hydroxy-4′-vinylthiophenylsulfide and 2-hydroxy-3-(meth)acryloylthiophenyl-2′-chloro-4′-vinylthiophenylsulfide.

Compounds having functional groups (acryl, methacryl, vinyl), substituents (halogen, lower alkyl, hydroxyl) and the organic groups M₃, M₄ at the 2nd-, 3rd-, 4th-position of the phenyl ring: 3-bromo-2-(meth)acryloyloxymethoxythiophenyl-2′-butyl-3′-vinylthiophenylsulfide, 2-hydroxy-2-(meth)acryloyloxyethoxythiophenyl-3′-hydroxy-4′vinylthiophenylsulfide, 3-ethyl-3-(meth)acryloyloxypropoxythiophenyl-2′chloro-4′-vinylthiophenylsulfide, 3-bromo-2-(meth)acryloyloxydimethoxy-thiophenyl-2′-butyl-3′-(meth)acryloyloxydiethoxythiophenylsulfide, 3-ethyl-2-(meth)acryloyloxydiethoxythiophenyl-3′-hydroxy-4′-(meth)acryloyloxydimethoxythiophenylsulfide and 2-hydroxy-3-(meth)acryloyloxydipropoxythiophenyl-2′-chloro-4′-(meth)acryloyloxy-dimethoxythiophenylsulfide.

Saturated cyclic hydrocarbon compounds:

1,3-Di(meth)acryloylthiocyclopentane, 1,4-di(meth)acryloylthio-cyclohexane, 1,4-di(meth)acryloylthiocycloheptane, 1,6-di(meth)acryloyl-thiocyclooctane, bis(3-(meth)acryloylthiocyclopentyl)sulfide, bis(4-(meth)acryloylthiocyclohexyl)sulfide, bis(4-(meth)acryloylthio-cycloheptyl)sulfide and bis(5-(meth)acryloylthiocyclooctyl)sulfide.

Unsaturated cyclic hydrocarbon compounds:

Bis(4-(meth)acryloylthio-2-cyclohexen-1-yl)sulfide, bis(4-(meth)acryloylthio-2-cyclopenten-1-yl)sulfide, bis(5-(meth)acryloylthio-2-cyclohepten-1-yl)sulfide and bis(5-(meth)acryloylthio-2-cycloocten-1-yl)sulfide.

Heterocyclic compounds:

Bis(2-(meth)acryloylthienyl)sulfide, bis(3-(meth)acryloylthiopyridyl)-sulfide, bis(5-(meth)acryloylthiopyranyl)sulfide and bis(5-(meth)acryloyl-thio-1,4-dithianyl)sulfide.

The above-mentioned compounds can be used solely or in combination.

Among the above-mentioned compounds, bis(4-methacryloylthiophenyl)sulfide, bis(4-acryloylthiophenyl)sulfide, bis(4-vinylthiophenyl)sulfide and the like are particularly preferable.

Next, the halogenated cyclic compound [III] is described.

In the general formula [III] of the halogenated cyclic compound, the circle represents cyclic structure, Y₂ is a ring member atom constituting the ring, and “k” is the number of the constituent atom Y₂ of the ring, namely the member number of the ring. “k” is preferably 5 to 8, more preferably 5 or 6, the most preferably 6. The plural atoms (Y₂)ₖ can be all carbon atoms (in this case, the ring is a carbon ring), or a portion of the plural atoms (Y₂)ₖ can be heteroatom(s) such as sulfur atom(s), nitrogen atom(s) and/or oxygen atom(s) and the rest atoms can be carbon atoms (in this case, the ring is a heterocycle). The ring can be saturated or unsaturated, the ring preferably has unsaturated bond(s), and the ring is particularly preferably a benzene ring.

X₄ is a substituent of the ring, at least one of the plural (X₄)_{q} is halogen and others are hydroxyl or lower alkyl. The substituent X₄ number “q” is 2 to 6.

In the organic group R₅, the radical polymerizable group can be a functional group such as vinyl, (meth)acryloyl or (meth)acryloyloxy. The organic group R₅ having no radical polymerizable group can be lower alkyl having one to five carbon atoms.

In —(OR)ₙ₃— of M₅, a carbon number of the lower alkylene R is preferably one to five, more preferably one to three. Examples of OR are oxymethylene, oxyethylene, oxypropylene, oxybutylene and the like. Examples of (OR)ₙ₃ (n3 is an integer of 2 to 5) are dioxymethylene, dioxyethylene, dioxypropylene, dioxybutylene, trioxymethylene, trioxyethylene, trioxypropylene, trioxybutylene, tetraoxymethylene, tetraoxyethylene, tetraoxypropylene, tetraoxybutylene and the like. When the lower alkylene R has hydroxyl, the hydroxyl can exist at any positions of the alkylene, and an example of the alkylene having hydroxyl is (2-hydroxy)propylene.

The group (M₅-R₅) number “p” is one to four.

The halogenated cyclic compounds [III], for example trihalophenol-based compounds can be the following compounds.

Compounds having one functional group (acryl, methacryl, vinyl) and two substituents (halogen, hydroxyl, lower alkyl):

2,4-Dibromophenyl(meth)acrylate, 2,6-dibromophenyl(meth)acrylate, 4,6-dichloro-1-vinylbenzene, 2,4-dibromo-5-ethyl-3-(meth)acryloyloxybenzene, 2,6-dibromo-3-hydroxyphenyl acrylate, 4,6-dibromo-2-propyl-1-vinylbenzene, 2,4-dichloro-3-methylphenyl(meth)acrylate, 2,6-dibromo-5-hydroxyphenyl(meth)acrylate, 4,6-dibromo-2-butyl-1-vinylbenzene, 2,4-dibromophenoxy(meth)acrylate, 2,6-dibromophenoxy (meth)acrylate, 2,4-dichloro-3-methylphenoxy(meth)acrylate, 2,6-dibromo-5-hydroxyphenoxy(meth)acrylate, 2,6-dichlorophenoxy(meth)acrylate, 2,4-dibromo-5-ethyl-1,3-di(meth)acryloylbenzene and 2,6-dichloro-3-hydroxyphenoxy(meth)acrylate.

Compounds having one functional group (acryl, methacryl, vinyl) and three substituents (halogen, hydroxyl, lower alkyl):

2,4,6-Tribromophenyl(meth)acrylate, 2,4,6-trichloro-1-vinylbenzene, 2,4,6-tribromophenoxyethyl(meth)acrylate, 2,3,6-tribromophenyl(meth)acrylate, 2,5,6-tribromophenyl(meth)acrylate, 2,4,5-trichloro-1-vinylbenzene, 2,4,6-tribromophenoxydiethylene glycol(meth)acrylate, 2,4,6-tribromophenoxytriethylene glycol(meth)acrylate, 2,4,6-tribromophenoxytetraethylene glycol(meth)acrylate, 2,4,6-trichlorophenoxymethyl(meth)acrylate, 2-(2,4,6-tribromophenoxy)ethyl(meth)acrylate, 2-(2,4,6-tribromophenoxy)propyl(meth)acrylate, 3-(2,4,6-tribromophenoxy)propyl (meth)acrylate, 2-(2,4,6-tribromophenoxy)-3-hydroxypropyl(meth)acrylate and 3-(2,4,6 -tribromophenoxy)-3-hydroxypropyl(meth)acrylate.

Compounds having two functional groups (acryl, methacryl, vinyl) and two substituents (halogen, hydroxyl, lower alkyl):

2,4-Dibromo-1,3-di(meth)acryloyloxybenzene, 5-(meth)acryloyloxy-2,4-dibromo-3-(meth)acryloyloxybenzene, 5-(meth)acryloyloxy-2-bromo-4-chloro-3-(meth)acryloyloxybenzene, 1-(meth)acryloyloxy-2,5-dibromo-4-hydroxy-3-methyl-6-(meth)acryloyloxybenzene and 1-(meth)acryloyloxy-2 -bromo-3-chloro-4-hydroxy-3-methyl-6-(meth)acryloyloxybenzene.

Compounds having two functional groups (acryl, methacryl, vinyl) and three substituents (halogen, hydroxyl, lower alkyl):

2,4-Dibromo-6-methyl-1,3,5-tri(meth)acryloyloxybenzene, 1,5-dibromo-3-hydroxy-2,4,6-tri(meth)acryloyloxybenzene and 1,5 -dichloro-3-hydroxy-2,4,6-tri(meth)acryloyloxybenzene.

Compounds having three functional groups (acryl, methacryl, vinyl) and three substituents (halogen, hydroxyl, lower alkyl):

2,4,6-Tribromo-1,3,5-tri(meth)acryloyloxybenzene and 2,4,6-trichloro-1,3,5-tri(meth)acryloyloxybenzene.

Compounds having functional groups (acryl, methacryl, vinyl), substituents (halogen, hydroxyl, lower alkyl) and the organic group M₅:

1,4-Di(meth)acryloyloxytrimethoxy-2,6-dibromobenzene, 1-(meth)acryloyloxyethoxy-2,3,6-tribromobenzene, 1-(meth)acryloyloxydipropoxy-2,4,6-trichlorobenzene, 2,4-dibromo-1,3-di(meth)acryloyloxymethoxybenzene and 2,4-dibromo-6-methyl-1,3,5-tri(meth)acryloyloxydiethoxybenzene.

These exemplified compounds can be used solely or in combination.

Among the above-mentioned compounds, tribromophenol acrylate, tribromophenol methacrylate, tribromophenoxyethyl acrylate, tribromophenoxyethyl methacrylate and the like are particularly preferable.

Next, the carbazole-based compound [IV] is described.

In the organic groups R₆, R₇ and R₈ of the carbazole-based compound [IV], the radical polymerizable group can be a functional group such as vinyl, (meth)acryloyl or (meth)acryloyloxy. The organic groups R₆, R₇ and R₈ having no radical polymerizable group can be lower alkyl having one to five carbon atoms.

In —(OR)ₙ₄— of M₆, M₇ and M₈, a carbon number of the lower alkylene R is preferably one to five, more preferably one to three. Examples of OR are oxymethylene, oxyethylene, oxypropylene, oxybutylene and the like. Examples of (OR)ₙ₄(n4 is an integer of 2 to 5) are dioxymethylene, dioxyethylene, dioxypropylene, dioxybutylene, trioxymethylene, trioxyethylene, trioxypropylene, trioxybutylene, tetraoxymethylene, tetraoxyethylene, tetraoxypropylene, tetraoxybutylene and the like. When the lower alkylene R has hydroxyl, the hydroxyl can exist at any positions of the alkylene, and an example of the alkylene having hydroxyl is (2-hydroxy)propylene.

X₅and X₆, being the same or different, are the substituents of the ring and are halogen, hydroxyl or lower alkyl.

The carbazole-based compounds [IV] can be the following compounds.

Compounds having one functional group (acryl, methacryl, vinyl):

1-Vinylcarbazole, 2-vinylcarbazole, 3-vinylcarbazole, 4-vinylcarbazole, 9-vinylcarbazole, 1-(meth)acryloyloxycarbazole, 2-(meth)acryloyloxycarbazole, 3-(meth)acryloyloxycarbazole, 4-(meth)acryloyloxycarbazole and 9-(meth)acryloyloxycarbazole.

Compounds having two or three functional groups (acryl, methacryl, vinyl):

1,9-Divinylcarbazole, 1,5,9-trivinylcarbazole, 2,7-di(meth)acryloyloxycarbazole, 2,8,9-tri(meth)acryloyloxycarbazole, 1,9-di(meth)acryloyloxycarbazole, 3,6,9-tri(meth)acryloyloxycarbazole, 2-(meth)acryloyloxy-1-vinylcarbazole, 6-(meth)acryloyloxy-2-vinylcarbazole, 2-(meth)acryloyloxy-9-(meth)acryloyloxycarbazole and 1-(meth)acryloyloxy-5-(meth)acryloyloxycarbazole.

Compounds having functional groups (acryl, methacryl, vinyl) and substituents (halogen, lower alkyl, hydroxyl):

2-Methyl-1,9-divinylcarbazole, 3-hydroxy-1,5,9-trivinylcarbazole, 1-chloro-2,7-di(meth)acryloyloxycarbazole, 3,7-dibromo-2,8,9-tri(meth)acryloyloxycarbazole, 1,9-di(meth)acryloyloxy-4-butylcarbazole, 3,6,9-tri(meth)acryloyloxy-1-hydroxycarbazole, 2-(meth)acryloyloxy-5-propyl-1-vinylcarbazole, 6-(meth)acryloyloxy-9-ethyl-2-vinylcarbazole, 2-(meth)acryloyloxy-9-(meth)acryloyloxycarbazole and 1-(meth)acryloyloxy-9-hydroxy-5-(meth)acryloyloxycarbazole.

Compounds having functional groups (acryl, methacryl, vinyl), substituents (halogen, lower alkyl, hydroxyl) and the organic groups M₆, M₇:

2-Methyl-1,9-divinylmethoxycarbazole, 3-hydroxy-1,5,9-trivinylethoxycarbazole, 1-chloro-2,7-di(meth)acryloyloxyethoxycarbazole, 3,7-dibromo-2,8,9-tri(meth)acryloyloxydiethoxycarbazole, 1,9-di(meth)acryloyloxytrimethoxy-4-butylcarbazole, 3,6,9-tri(meth)acryloyloxytetramethoxy-1-hydroxycarbazole, 2-(meth)acryloyloxymethoxy-5-propyl-1-vinylcarbazole, 6-(meth)acryloyloxydimethoxy-9-ethyl-2-vinylcarbazole, 2-(meth)acryloyloxytripropoxy-9-(meth)acryloyloxymethoxycarbazole and 1-(meth)acryloyloxyethoxy-9-hydroxy-5-(meth)acryloyloxyethoxycarbazole.

These exemplified compounds can be used solely or in combination.

Among the above-mentioned compounds, N-vinylcarbazole, 3,6-dibromo-9-vinylcarbazole and 9-vinylcarbazole are particularly preferable.

It is also possible to combine the respective exemplified compounds of the fluorene-based compound [I], the sulfide-based cyclic compound [II], the halogenated cyclic compound [III] and the carbazole-based compound [IV].

Among the fluorene-based compound [I], the sulfide-based cyclic compound [II], the halogenated cyclic compound [III] and the carbazole-based compound [IV], the fluorene-based compound [I], the sulfide-based cyclic compound [II] and the halogenated cyclic compound [III] are preferable, and the fluorene-based compound [I] and the halogenated cyclic compound [III] are the most preferable.

In the hologram recording material composition of the invention, the allyl-based prepolymer (A) (containing (D), if necessary) and the (meth)acrylate-based compound (B) are selected in such a manner that the difference between the refractive index of the former and the refractive index of the polymer of the latter is 0.005 or more, and preferably 0.01 or more. When the difference is less than 0.005, the formation of a hologram is substantially impossible. The difference is 1.0 at the most.

In the hologram recording material composition according to the present invention, a weight ratio of the allyl-based prepolymer (A) to the (meth)acrylate-based compound (B),(A):(B) is from 5:95 to 95:5, preferably from 10:90 to 90:10, further preferably from 20:80 to 80:20, the most preferably from 30:70 to 70:30.

The hologram recording material composition according to the present invention can further comprise a viscosity reducing agent (E) other than the allyl-based prepolymer (A), the (meth)acrylate-based compound (B) and the photo-polymerization initiator (C). A weight ratio of the allyl-based prepolymer (A), the (meth)acrylate-based compound (B) and the viscosity reducing agent (E),(A):(B):(E) is 20 to 80:3 to 60:3 to 60, preferably 30 to 75:5 to 50:5 to 50. The viscosity reducing agent (E) is selected in such a manner that a difference between the refractive index of the polymer of the (meth)acrylate-based compound (B) and the weighted mean of those of the allyl-based prepolymer (A), the thermoplastic resin (D) and the viscosity reducing agent (E) is 0.01 or more.

When at least one radical polymerizable compound (b1) selected from the group consisting of the fluorene-based compound [I], the sulfide-based cyclic compound [II], the halogenated cyclic compound [III] and the carbazole-based compound [IV] is used as the (meth)acrylate-based compound (B), it is desirable to use the viscosity reducing agent (E) simultaneously. Since the radical polymerizable compound (b1) is usually solid at ordinary temperature, it is difficult to obtain good diffraction efficiency unless the viscosity reducing agent (E) is used simultaneously. In particular, in recording of a reflection type hologram, the diffraction efficiency might be lowered, or it might be impossible to record the hologram.

Among the viscosity reducing agents, examples of compounds (e1) which are nonreactive on the (meth)acrylate-based compound (B) are inert compounds such as phthalates such as dimethyl phthalate and diethyl phthalate; aliphatic dibasic acid esters such as dimethyl adipate, dibutyl adipate, dimethyl sebacate and diethyl succinate; orthophosphates such as trimethyl phosphate, triethyl phosphate, triphenyl phosphate and tricresyl phosphate; acetates such as glyceryl triacetate and 2-ethylhexyl acetate; and phosphites such as triphenyl phosphite and dibutylhydrodiene phosphite. A further example thereof is alkylene glycol alkyl ether represented by the following general formula,

R₁₁(CH₂CH₂O)ₙR₁₂ [V]

wherein R₁₁ and R₁₂ are alkyl having one to five carbon atoms, hydroxyl or acetyl, and “n” is an integer of 1 to 5.

Examples of the alkylene glycol alkyl ether are ethylene glycol dimethyl ether, ethylene glycol diethyl ether, ethylene glycol dipropyl ether, ethylene glycol monomethyl ether, ethylene glycol monoethyl ether, ethylene glycol monopropyl ether, diethylene glycol dimethyl ether, diethylene glycol diethyl ether, diethylene glycol dipropyl ether, diethylene glycol monomethyl ether, diethylene glycol monoethyl ether, diethylene glycol monopropyl ether, triethylene glycol dimethyl ether, triethylene glycol diethyl ether, triethylene glycol dipropyl ether, triethylene glycol monomethyl ether, triethylene glycol monoethyl ether, triethylene glycol monopropyl ether, cellosolve acetate ethylene glycol diacetyl ether, ethylene glycol monoacetyl ether, diethylene glycol diacetyl ether, diethylene glycol monoacetyl ether, triethylene glycol diacetyl ether and triethylene glycol monoacetyl ether.

It is also possible to use polyethylene glycol having a weight-average molecular weight of 10,000 or lower or silicone oil.

The nonreactive compound (e1) preferably has a refractive index much smaller than that of the allyl-based prepolymer (A).

Among the viscosity reducing agents (E), examples of compounds (e2) having methallyl and/or allyl in a molecule thereof are mono(meth)allyl compounds such as (meth)allyl alcohol, (meth)allyl chloride, (meth)allyl acetate, (meth)allyl benzoate, (meth)allyl isovalerate, (meth)allyl caprylate, (meth)allyl caproate, (meth)allyl formate, (meth)allyl cinnamate, (meth)allyl salicylate, (meth)allyl dihydrojasmonate, (meth)allyl phenylacetate, (meth)allyl propionate, (meth)allyl butyrate, mono(meth)allyl adipate, mono(meth)allyl sebacate, mono(meth)allyl phthalate, mono(meth)allyl isophthalate, mono(meth)allyl terephthalate, mono(meth)allyl succinate, mono(meth)allyl trimellitate, mono(meth)allyl succinate, mono(meth)allyl ricinoleate and mono(meth)allyl maleate; di(meth)allyl compounds such as di(meth)allyl adipate, di(meth)allyl sebacate, di(meth)allyl phthalate, di(meth)allyl isophthalate, di(meth)allyl terephthalate, di(meth)allyl succinate, di(meth)allyl trimellitate, di(meth)allyl succinate, di(meth)allyl ricinoleate and di(meth)allyl maleate, tri(meth)allyl phosphate, tri(meth)allyl isocyanurate and the like. It is also preferable to select a viscosity reducing agent (e2) having a refractive index much smaller than that of the allyl-based prepolymer (A).

The above-mentioned compounds can be used solely or in combination.

As the photo-polymerization initiator (C) used in the composition of the invention, there can be used those forming a radical by absorbing light being excellent in coherence. There can suitably be used those forming a radical by absorbing laser light, such as Kr laser (wavelength: 647 nm), He—Ne laser (wavelength: 633 nm), YAG laser (wavelength: 532 nm), Ar laser (wavelength: 515 and 488 nm) and He—Cd laser (wavelength: 442 nm) as light sources. As the photo-polymerization initiator, for example, there can preferably be used a carbonyl compound, an amine compound, an arylaminoacetic acid compound, an organotin compound, an alkylarylborate, an onium salt, an iron arene complex, a trihalogenomethyl-substituted triazine compound, an organic peroxide, a bisimidazole derivative, a titanocene compound and combinations of these initiators and a photosensitizing dye.

Examples of the carbonyl compound include benzil, benzoin ethyl ether, benzophenone and diethoxyacetophenone.

Examples of the amine compound are triethanolamine, triisopropanolamine, 2-dimethylaminobenzoic acid and the like.

An example of the arylaminoacetic acid compound is N-phenylglycine.

An example of the organotin compound is tributylbenzyltin.

Examples of the alkylarylborate are tetrabutylammonium triphenylbutylborate and triphenyl-n-butylborate.

An example of the onium salt is a diphenyliodonium salt.

An example of the iron arene complex is η⁵-cyclopentadienyl-η⁶-cumenyl-iron (1+)-hexafluorophosphate (1−).

An example of the trihalogenomethyl-substituted triazine compound is tris(trichloromethyl)triazine.

An example of the organic peroxide is 3,3′,4,4′-tetra(tert-butylperoxycarbonyl)benzophenone.

Examples of the bisimidazole derivative are 2,2′-bis(o-chlorophenyl)-4,4′,5,5′-tetraphenyl-1,1′-biimidazole and bis(2,4,5-triphenyl)imidazolyl.

An example of the titanocene compound is bis(η⁵-2,4-cyclopentadien-1-yl)-bis(2,6-difluoro-3-(1H-pyrrol-1-yl)phenyl)titanium.

These can be used solely or in combination.

As the photosensitizing dye, Michler's ketone, Acridine Yellow, merocyanine, methylene blue, camphorquinone, Eosin and decarboxylated rose bengal are preferably used. Any photosensitizing dye can be used as far as it exhibits absorption in the visible region, and in addition to the above, a cyanine derivative, a merocyanine derivative, a phthalocyanine derivative, a xanthene derivative, a thioxanthene derivative, an acridine derivative, a porphyrin derivative, a coumarin derivative, a basestyryl derivative, a ketocoumarin derivative, a quinolone derivative, a stilbene derivative, an oxazine derivative and a thiazine dye can be used. Furthermore, photo-sensitizing dyes described in Dye Handbook, edited by S. Ohgawara, et al. (Kodansha, 1986), Chemistry of Functional Dyes, edited by S. Ohgawara, et al. (CMC, 1983), and Special Functional Materials, edited by C. Ikemori, et al. (CMC, 1986) can be used. These can be used singly or in combination of two or more.

Examples of the coumarin derivative are 3-(2-benzothiazolyl)-7-(diethylamino)coumarin, 3-(2-benzothiazolyl)-7-(dibutylamino)coumarin, 3-(2-benzothiazolyl)-7-(dioctylamino)coumarin, 3-(2-benzimidazolyl)-7-(diethylamino)coumarin and the like.

Examples of the ketocoumarin derivative are 3,3′-carbonylbis(7-diethylaminocoumarin), 3,3′-carbonylbis-7-diethylaminocoumarin-7′-bis(butoxyethyl)aminocoumarin, 3,3′-carbonylbis(7-dibutylaminocoumarin) and the like.

Examples of the basestyryl derivative are 2-[p-(dimethylamino)styryl]benzothiazole, 2-[p-(dimethylamino)styryl]naphtho[1,2-d]thiazole, 2-[(m-hydroxy-p-methoxy)styryl]benzothiazole and the like.

Examples of the merocyanine derivative are 3-ethyl-5-[(3-ethyl-2(3H)-benzothiazolylidene)ethylidene]-2-thioxo-4-oxazolidinone, 5-[(1,3-dihydro-1,3,3-trimethyl-2H-indol-2-ylidene)ethylidene]-3-ethyl-2-thioxo-4-oxazolidinone and the like.

Specific examples of a combination of the organic peroxide and the photosensitizing dye include combinations of 3,3′,4,4′-tetra(tert-butylperoxycarbonyl)benzophenone and NKX653, NKX3883, NKX1880, NKX1595, NKX1695, NK4256, NK1886, NK1473, NK1474, NK4795, NK4276, NK4278, NK91, NK1046, NK1237, NK1420, NK1538, NK3590 and the like, which are photosensitizing dyes produced by Nippon Photosensitizing Dye Laboratory Co., Ltd.

Specific examples of a combination of the carbonyl compound and the photosensitizing dye include benzil-Michler's ketone, and benzil-Acridine Yellow. As the photosensitizing dye used in combination with the amine compound, decarboxylated rose bengal is preferred. As the photosensitizing dye used in combination with the borate compound, a cyanine-based dye, such as a cyanine, an isocyanine and a pseudocyanine.

The amount of the photo-polymerization initiator (C) added to the composition of the invention is generally about from 0.1 to 15% by weight, and preferably about from 0.3 to 10% by weight, based on 100 parts by weight of the total amount of the allyl-based prepolymer (A), the (meth)acrylate-based compound (B) and the viscosity reducing agent (E) in the case where the carbonyl compound is used.

The hologram recording material composition of the invention can contain additives, such as a viscosity adjusting agent, a compatibility adjusting agent, a heat polymerization inhibitor and a chain transfer agent, and a solvent, if necessary.

Inorganic fine particles and organic fine particles can be used as the viscosity adjusting agent. Examples of inorganic fine particles include silica gel fine particles “Daiso gel SP series” produced by Daiso Co., Ltd., “Silicia” and “Fuji silica gel” produced by Fuji Silicia Chemical Co., Ltd., “Carplex” produced by Shionogi & Co., Ltd., “Aerosil” produced by Nippon Aerosil Co., Ltd., “Reorosil”, “Tokusil” and “Finesil” produced by Tokuyama Co., Ltd. and the like. Examples of organic fine particles include a diallyl phthalate-based polymer which can be obtained by methods described in JP-A 10-72510 and JP-A 10-310684; and “PB 200 series” produced by Kao Corporation, “Bell Pearl series” produced by Kanebo Ltd., “Techpolymer series” produced by Sekisui Plastics Co., Ltd., “Micropearl series” produced by Sekisui Fine Chemical Co., Ltd., and “MR series” and “MP series” both produced by Soken Chemical & Engineering Co., Ltd., which are described in “Most advanced technology of microfine particles”, edited by S. Muroi (CMC, 1991).

The amount of the viscosity adjusting agent added is preferably about from 0.5 to 30 parts by weight per 100 parts by weight of the total amount of the allyl-based prepolymer (A), the (meth)acrylate-based compound (B) and the viscosity reducing agent (E).

The solvent to be used is a non-aqueous organic solvent. The solvent is effective to improve the film forming property, as well as the viscosity adjustment and the compatibility adjustment. For example, it is possible to use non-aqueous organic solvents such as acetone, xylene, toluene, methyl ethyl ketone, tetrahydrofuran, benzene, methylene chloride, dichloromethane, chloroform, methanol and acetonitrile. The amount of the solvent used is about from 0.5 to 1,000 parts by weight per 100 parts by weight of the total amount of the allyl-based prepolymer (A), the (meth)acrylate-based compound (B) and the viscosity reducing agent (E).

Examples of the heat polymerization inhibitor include hydroquinone, p-methoxyphenol, tert-butylcatechol, naphthylamine, diphenylpicrylhydrazine, diphenylamine and the like, which work to consuming the forming radicals.

Examples of the chain transfer agent include an α-methylstyrene dimer, 2-mercaptobenzoxazole, 2-mercaptobenzothiazole, tert-butyl alcohol, n-butanol, isobutanol, isopropylbenzene, ethylbenzene, chloroform, methyl ethyl ketone, propylene, vinyl chloride and the like.

In order to prepare the hologram recording material composition, for example, the allyl-based prepolymer (A), the (meth)acrylate-based compound (B), the photo-polymerization initiator (C) and the viscosity reducing agent (E), as well as the optional components described above such as the solvent-soluble thermoplastic resin (D), the additives and the solvent are placed in a vessel resistant to an organic solvent, such as a glass beaker, and the whole content is stirred. In this case, in order to accelerate dissolution of solid components, the composition can be heated to a range in which denaturation of the composition does not occur, such as to a temperature of about from 40 to 90° C.

In order to produce a hologram recording medium by using the hologram recording material composition of the invention, the recording material composition is coated on one surface of a substrate to obtain a recording medium having a two-layer structure consisting of the coated film thus formed, i.e., a recording layer, and the substrate. A three-layer structure is obtained, if necessary, by placing a protective material in the form of a film, a sheet or a plate to cover the recording layer formed on the substrate. In the process for preparing the composition, a solvent is preferably used. In this case, the allyl-based prepolymer (A), the (meth)acrylate-based compound (B), the photo-polymerization initiator (C) and the viscosity reducing agent (E) are dissolved or suspended in a solvent, and a solution or a suspension thus obtained is coated on a substrate. Thereafter, the solvent is vaporized to obtain a recording layer. In the case where a protective material is placed to cover the recording layer, it is preferred that the solvent is removed by air drying or vaporization under reduced pressure before placing the protective material. The substrate is made of an optically transparent material, such as a glass plate and a plastic plate, such as a polyethylene terephthalate (hereinafter abbreviated as PET) plate, a polycarbonate plate and a polymethyl methacrylate plate. The thickness of the substrate is preferably from 0.5 to 10 mm. The protective material is also made of an optically transparent material as similar to the substrate. The substrate does not necessarily have to be flat, but can be bent or curved and can have an uneven structure on the surface thereof. The thickness of the protective material is preferably from 0.01 to 10 mm. Examples of the coating method include a gravure coating method, a roll coating method and a bar coating method. The coating is preferably conducted in such a manner that the thickness of the recording layer after removing the solvent is from 1 to 100 μm.

In order to record a hologram onto the hologram recording medium, a recording method generally employed can be used. That is, a light source being excellent in coherence such as laser light is split into two with a beam splitter or the like, one split light is irradiated onto an object to be recorded, and the other is reflected with a reflector as it is. A recording medium is arranged at a specified position. At the position an interference fringe can be caught which is formed with reference light reflected from the reflector and object light reflected from the object. When the object light and the reference light enter the recording medium from the same face, a transmission type hologram is formed. When the object light and the reference light enter from a front face and a rear face respectively, a reflection type hologram is formed. It is unnecessary to use the object to be recorded in the above-mentioned recording method, and in this case, a fringe is formed as grating. Irradiating laser light for about from several seconds to several minutes under such an arrangement, an interference fringe to be a hologram is recorded on the recording medium. The light amount of the laser light used is, in terms of a product of the light intensity and the irradiation time, preferably about from 10 to 10,000 mJ/cm². When the light amount is less than the range, recording is difficult to be conduct, whereas when it exceeds the range, the diffraction efficiency of the hologram tends to be lowered, and therefore the both cases are not preferred.

After forming the hologram, a post-processing, such as development and fixing, is not always necessary, but in order to stabilize the resulting image, the medium can be subjected to a irradiation treatment with light on the whole surface thereof or a heat treatment to post-polymerize the remaining unreacted monomer.

A hologram can be copied on a recording medium obtained by using the recording medium composition of the invention. For example, a recorded hologram plate, as an original image, is superposed closely on the surface of the protective material of the recording material having the three-layer structure described above, and the hologram plate having the original image is irradiated with light using a high pressure mercury lamp. Interference occurs at the recording layer of the non-recorded recording medium between reference light suffering no diffraction and diffracted light of the original image (i.e., object light), and the hologram is copied onto the recording medium to obtain a hologram of high fidelity to the original image. When a hologram of good quality can be obtained by the copying process described above, such becomes evidence that a hologram can be produced by interference of laser light.

After producing a hologram in the recording medium obtained by using the recording material composition of the invention, the prepolymer (A) remains in the recording medium. Therefore, it is considered that the remaining allyl-based prepolymer is functionally utilized. For example, when the substrate is formed with an unsaturated polyester resin, and the remaining allyl group of the prepolymer (A) is chemically bonded to an unsaturated group of the resin of the substrate, the recording material composition of the invention can be firmly fixed on the substrate. By utilizing the function of the remaining allyl group of the allyl-based prepolymer (A), various properties can be given to the material characteristics of the hologram to obtain a hologram that has physical properties applicable to various kinds of usage.

In the recording material composition of the invention, the allyl-based prepolymer (A) and the (meth)acrylate-based compound (B) are completely dissolved each other before exposure to light, and on irradiation with laser light, the (meth)acrylate-based compound (B) is polymerized through photo-polymerization, and finally becomes a hologram recording layer.

Accordingly, when the two-layer structure, which comprises a substrate having the recording material composition coated thereon, or the three-layer structure, which comprises the two-layer structure having a protective layer formed on the recording layer, is exposed to an interference pattern, photo-polymerization of the (meth)acrylate-based compound (B) having a high photo-polymerization reactivity begins to occur at a portion of a large light amount, and volume shrinkage occurs at that portion. An unreacted compound flows from a portion of a small light amount into a concave portion formed by the volume shrinkage, and the allyl-based prepolymer (A) diffuses into the portion of a small light amount by phase separation between the allyl-based prepolymer (A) and the (meth)acrylate-based compound (B).

The (meth)acrylate-based compound (B) is diffused to migrate into the portion of a large light amount to further proceed the photo-polymerization. In the portion of a small light amount, on the other hand, the photo-polymerization of the allyl-based prepolymer (A) proceeds solely or with a polymer of the (meth)acrylate-based compound (B) with a small delay from the portion of a large light amount. As a result, a structure wherein the polymer of the (meth)acrylate-based compound (B) is accumulated in the portion of a large light amount, the allyl-based prepolymer (A) is accumulated in the portion of a small light amount, and they are linked each other by radical copolymerization is formed.

When the viscosity reducing agent (E) exists in the system, this agent is a component to adjust viscosity and compatibility of the system and functions as a component to promote the separation between the allyl-based prepolymer (A) and the (meth)acrylate-based compound (B). This agent exists uniformly in the system in the early stage of the exposure to light but is finally excluded into the portion of a small light amount, namely to the allyl-based prepolymer (A) side. Accordingly, a compositional distribution corresponding to an interference pattern, which is a light amount distribution of the interference fringe, i.e., a portion having large amounts of the allyl-based prepolymer (A) and the viscosity reducing agent (E) and a portion having a large amount of the (meth)acrylate-based compound (B) are formed as a distribution of refractive indexes, i.e., a hologram.

Similarly, when the thermoplastic resin (D) exists in the system, this resin is a component to adjust the viscosity and the compatibility of the system and is finally excluded to the allyl-based prepolymer (A) side.

### BRIEF DESCRIPTION OF THE DRAWINGS

FIG. 1 is a schematic drawing showing an example of a transmission type hologram.

FIG. 2 is a schematic drawing showing an example of a reflection type hologram.

### DESCRIPTION OF THE PREFERRED EMBODIMENTS

The invention will be specifically described with reference to several examples, but the invention is not construed as being limited thereto.

### EXAMPLE 1

(1) 8 g of diallylorthophthalate prepolymer (“Daiso DAP Type A” produced by Daiso Co., Ltd.), 2 g of ethylene glycol dimethacrylate (“NK Ester 1G” produced by Shin-Nakamura Chemical Co., Ltd.), 0.3 g of benzil as a polymerization initiator, 0.1 g of Michler's ketone as a photo-sensitizing dye, and 22 g of acetone were mixed at an ordinary temperature to prepare a recording material composition comprising these components.

(2) The composition was coated on one surface of a glass plate substrate having a dimension of 76×26×1.2 mm to a thickness of 10 μm. Acetone was removed from the coated layer under reduced pressure, to produce a recording material having a two-layer structure comprising the substrate and the recording layer.

In the recording layer of the recording material, no phase separation or deposition of a polymer and a monomer was observed. Since the recording layer was substantially in a solid state, when touched with hand, it was not attached to hand, and did not drip. Therefore, the recording layer was excellent in handling, suffered no shift from the substrate, and was easy to transport. Further, the thickness of the recording layer was kept constant.

(3) A protective material comprising a PET film having a size of 76×26 mm and a thickness of 10 μm was placed to cover the recording layer, to produce a three-layer photosensitive plate for recording a hologram.

(4) Another hologram plate (diffraction efficiency: ca. 60%, resolution: ca. 2,000 lines per mm), in which 70 lines per mm had been recorded, as an original image was superposed closely on the surface of the protective material of the non-recorded photosensitive plate, and the hologram plate as the original image was irradiated with light emitted from a high pressure mercury lamp of 100 W (having peak wavelengths at 365, 410 and 430 nm) from the upper side thereof with a distance of about 10 cm for 1 to 3 minutes, so as to copy the hologram to the non-recorded photosensitive plate. When the illuminance was measured with an illuminance meter capable of measuring a wavelength of from 330 to 490 nm, the energy was 3.0 mW/cm² or less at a distance of 10 cm from the light source. Therefore, even when the recording was continued for 10 minutes, the energy became only about 1,800 mJ/cm².

A copy thus obtained suffered no coloring, and had a high brightness of a diffraction efficiency of about 30% without conducting development and fixing.

The copied hologram maintained a stable image for a long period of 3 months or more, after peeling the protective material. The record was formed only with the refractive index modulation, but not unevenness on the recording layer, and a transparent hologram having substantially no absorption in the visible region was obtained.

Since a hologram of good quality was obtained through the copying process described above, it was evidenced that a hologram could be produced by laser interference.

### EXAMPLES 2 TO 8

(1) The same procedures as in item (1) of Example 1 were repeated to produce recording material compositions, except that the ratio of the diallylorthophthalate prepolymer and ethylene glycol dimethacrylate was changed as follows:

prepolymer/monomer=9/1 (g/g) (Example 2)

prepolymer/monomer=7/3 (g/g) (Example 3)

prepolymer/monomer=6/4 (g/g) (Example 4)

prepolymer/monomer=5/5 (g/g) (Example 5)

prepolymer/monomer=4/6 (g/g) (Example 6)

prepolymer/monomer=3/7 (g/g) (Example 7)

prepolymer/monomer=2/8 (g/g) (Example 8)

(2) to (4) Photosensitive plates for recording a hologram were produced and holograms were copied by conducting the same manner as in items (2) to (4) of Example 1.

Copies thus obtained suffered no coloring, and had a high brightness of a diffraction efficiency of about 30% without conducting development and fixing.

The copied holograms maintained a stable image for a long period of 3 months or more, after peeling the protective material. The records were formed only with the refractive index modulation, but not unevenness on the recording layer, and transparent holograms having substantially no absorption in the visible region were obtained.

### EXAMPLE 9

(1) 3.5 g of diallylorthophthalate prepolymer (“Daiso DAP Type K” produced by Daiso Co., Ltd.), 1.5 g of ethylene glycol dimethacrylate (“NK Ester 1G” produced by Shin-Nakamura Chemical Co., Ltd.), 0.15 g of benzil, 0.05 g of Michler's ketone, and 11 g of acetone were mixed at an ordinary temperature to prepare a recording material composition comprising these components.

(2) to (4) A photosensitive plate for recording a hologram was produced and a hologram was copied by conducting the same manner as in items (2) to (4) of Example 1.

A copy thus obtained suffered no coloring, and had a high brightness of a diffraction efficiency of about 30% without conducting development and fixing.

The copied hologram maintained a stable image for a long period of 3 months or more, after peeling the protective material. The record was formed only with the refractive index modulation, but not unevenness on the recording layer, and a transparent hologram having substantially no absorption in the visible region was obtained.

### EXAMPLE 10

(1) The same procedures as in item (1) of Example 9 were repeated to produce a recording material composition, except that the diallylorthophthalate prepolymer was changed to diallylisophthalate prepolymer (“Daiso ISO-DAP” produced by Daiso Co., Ltd.).

(2) to (4) A photosensitive plate for recording a hologram was produced and a hologram was copied by conducting the same manner as in items (2) to (4) of Example 1.

A copy thus obtained suffered no coloring, and had a high brightness of a diffraction efficiency of about 30% without conducting development and fixing.

The copied hologram maintained a stable image for a long period of 3 months or more, after peeling the protective material. The record was formed only with the refractive index modulation, but not unevenness on the recording layer, and a transparent hologram having substantially no absorption in the visible region was obtained.

### EXAMPLES 11 TO 23

(1) The same procedures as in item (1) of Example 9 were repeated to produce recording material compositions, except that the diallylorthophthalate prepolymer (“Daiso DAP Type K” produced by Daiso Co., Ltd.) was changed to diallylorthophthalate prepolymer (“Daiso DAP Type A” produced by Daiso Co., Ltd.), and the ethylene glycol dimethacrylate was changed to the following.

Triethylene glycol dimethacrylate (“NK Ester 3G” produced by Shin-Nakamura Chemical Co., Ltd.) (Example 11)

1,3-Butanediol dimethacrylate (“NK Ester BG” produced by Shin-Nakamura Chemical Co., Ltd.) (Example 12)

1,6-Hexanediol dimethacrylate (“NK Ester HD” produced by Shin-Nakamura Chemical Co., Ltd.) (Example 13)

Neopentyl glycol dimethacrylate (“NK Ester NPG” produced by Shin-Nakamura Chemical Co., Ltd.) (Example 14)

Tetraethylene glycol diacrylate (“NK Ester A-200” produced by Shin-Nakamura Chemical Co., Ltd.) (Example 15)

Nonaethylene glycol diacrylate (“NK Ester A-400” produced by Shin-Nakamura Chemical Co., Ltd.) (Example 16)

1,6-Hexanediol diacrylate (“NK Ester A-HD” produced by Shin-Nakamura Chemical Co., Ltd.) (Example 17)

Neopentyl glycol diacrylate (“NK Ester A-NPG” produced by Shin-Nakamura Chemical Co., Ltd.) (Example 18)

Trimethylolpropane trimethacrylate (“NK Ester TMPT” produced by Shin-Nakamura Chemical Co., Ltd.) (Example 19)

Trimethylolpropane triacrylate (“NK Ester A-TMPT” produced by Shin-Nakamura Chemical Co., Ltd.) (Example 20)

Tetramethylolmethane tetraacrylate (“NK Ester A-TMMT” produced by Shin-Nakamura Chemical Co., Ltd.) (Example 21)

Dipentaerythritol hexaacrylate (“NK Ester ADP-6” produced by Shin-Nakamura Chemical Co., Ltd.) (Example 22)

9,9-Bis(4-(2-acryloyloxyethoxy)phenyl)fluorene (“BPEFA” produced by Osaka Gas Co., Ltd.) (Example 23)

(2) to (4) Photosensitive plates for recording a hologram were produced and holograms were copied by conducting the same manner as in items (2) to (4) of Example 1.

Copies thus obtained suffered no coloring, and had a high brightness of a diffraction efficiency of about 30% without conducting development and fixing.

The copied holograms maintained a stable image for a long period of 3 months or more, after peeling the protective material. The records were formed only with the refractive index modulation, but not unevenness on the recording layer, and transparent holograms having substantially no absorption in the visible region were obtained.

### EXAMPLE 24

(1) 6 g of diallylorthophthalate prepolymer (“Daiso DAP Type A” produced by Daiso Co., Ltd.), 4 g of ethylene glycol dimethacrylate (“NK Ester 1G” produced by Shin-Nakamura Chemical Co., Ltd.), 0.5 g of benzil, 0.17 g of Michler's ketone, and 22 g of acetone were mixed at an ordinary temperature to prepare a recording material composition comprising these components.

(2) The composition was coated on one surface of a glass plate substrate having a dimension of 50×60×1.5 mm to a thickness of 10 μm. Acetone was removed from the coated layer under reduced pressure, to produce a recording material having a two-layer structure comprising the substrate and the recording layer.

(3) A protective material comprising a glass plate having the same size as the substrate was placed to cover the recording layer, to produce a three-layer photosensitive plate of a sandwich form for recording a hologram.

(4) An object to be recorded was irradiated with He—Cd laser light, and interference was formed between reference light reflected from a reflector and object light reflected from the object. The three-layer photosensitive plate for recording a hologram was placed at a position, at which a fringe pattern formed by the interference could be caught. The photosensitive plate was exposed to the He—Cd laser light (9 mW/cm²) for a prescribed period of time under the conditions, and an interference fringe to be a hologram could be recorded on the photosensitive plate only by this operation with an exposure time of either 15 seconds, 30 seconds, 45 seconds, 1 minute, 2 minutes, 5 minutes or 10 minutes.

No operation of development or fixing was necessary. Because the recording layer was sandwiched by the two glass plates, the thickness of the recording layer was uniform after exposure. There was no unevenness between a portion that had been irradiated with light of a high intensity and a portion that had been irradiated with light of a low intensity, and the record was formed with a refractive index modulation. A transparent hologram having a high brightness (resolution: 940 lines per mm) and substantially no absorption in the visible region was thus obtained. A stable image was maintained after removing the protective material.

### EXAMPLE 25

(1) 5 g of diallylorthophthalate prepolymer (“Daiso DAP Type A” produced by Daiso Co., Ltd.), 5 g of ethylene glycol dimethacrylate (“NK Ester 1G” produced by Shin-Nakamura Chemical Co., Ltd.), 0.5 g of benzil, 0.17 g of Michler's ketone, and 22 g of acetone were mixed at an ordinary temperature to prepare a recording material composition comprising these components.

(2) The composition was coated on one surface of a glass plate substrate having a dimension of 50×60×1.5 mm to a thickness of 10 μm. Acetone was removed from the coated layer under reduced pressure, to produce a recording material having a two-layer structure comprising the substrate and the recording layer.

(3) A protective material comprising a PET film having a size of 50×60 mm and a thickness of 10 μm was placed to cover the recording layer, to produce a three-layer photosensitive plate for recording a hologram.

(4) An object to be recorded was irradiated with He—Cd laser light, and interference was formed between reference light reflected from a reflector and object light reflected from the object. The three-layer photosensitive plate for recording a hologram was placed at a position, at which a fringe pattern formed by the interference could be caught. The photosensitive plate was exposed to the He—Cd laser light (9 mW/cm²) for a prescribed period of time under the conditions, and an interference fringe to be a hologram could be recorded on the photosensitive plate only by this operation with an exposure time of either 15 seconds, 30 seconds, 45 seconds, 1 minute, 2 minutes, 5 minutes or 10 minutes.

No operation of development or fixing was necessary. Because the recording layer was sandwiched by the glass plate and the protective material comprising the PET film, the thickness of the recording layer was uniform after exposure. There was no unevenness between a portion that had been irradiated with light of a high intensity and a portion that had been irradiated with light of a low intensity, and the record was formed with a refractive index modulation. A transparent hologram having a high brightness (resolution: 940 lines per mm) and substantially no absorption in the visible region was thus obtained. A stable image was maintained after removing the protective material.

### EXAMPLE 26

(1) A recording material composition was produced by repeating the same procedures as in item (1) of Example 1.

(2) The composition was coated on one surface of a glass plate substrate having a dimension of 50×60×1.5 mm to a thickness of 10 μm. Acetone was removed from the coated layer under reduced pressure, to produce a recording material having a two-layer structure comprising the substrate and the recording layer.

(3) A protective material comprising a glass plate having the same size as the substrate was placed to cover the recording layer, to produce a three-layer photosensitive plate of a sandwich form for recording a hologram.

(4) An object to be recorded was irradiated with He—Cd laser light, and interference was formed between reference light reflected from a reflector and object light reflected from the object. The three-layer photosensitive plate for recording a hologram was placed at a position, at which a fringe pattern formed by the interference could be caught. The photosensitive plate was exposed to the He—Cd laser light (10 mW/cm²) for a prescribed period of time under the conditions, and an interference fringe to be a hologram could be recorded on the photosensitive plate only by this operation.

No operation of development or fixing was necessary. Because the recording layer was sandwiched by the two glass plates, the thickness of the recording layer was uniform after exposure. There was no unevenness between a portion that had been irradiated with light of a high intensity and a portion that had been irradiated with light of a low intensity, and the record was formed with a refractive index modulation. A transparent hologram having a high brightness (diffraction efficiency: 60%, resolution: 2,000 or more lines per mm) and substantially no absorption in the visible region was thus obtained. A stable image was maintained after removing the protective material.

The recording material compositions obtained in Examples 1 to 23 and capability of copying conducted by using them are shown in Tables 1 and 2.

TABLE 1

| EXAM- | | | Benzil | Michler's | acetone | |
|---|---|---|---|---|---|---|
| PLE | polymer | monomer | (g) | ketone (g) | (g) | copying |
| 1 | 8 | 2 | 0.3 | 0.1 | 22 | good |
| 2 | 9 | 1 | 0.3 | 0.1 | 22 | good |
| 3 | 7 | 3 | 0.3 | 0.1 | 22 | good |
| 4 | 6 | 4 | 0.3 | 0.1 | 22 | good |
| 5 | 5 | 5 | 0.3 | 0.1 | 22 | good |
| 6 | 4 | 6 | 0.3 | 0.1 | 22 | good |
| 7 | 3 | 7 | 0.3 | 0.1 | 22 | good |
| 8 | 2 | 8 | 0.3 | 0.1 | 22 | good |

polymer: diallylorthophthalate prepolymer (Daiso DAP, Type A)
monomer: ethylene glycol dimethacrylate

TABLE 2

| | polymer | monomer | copying |
|---|---|---|---|
| 9 | polymer 1 | ethlene glycol dimethacrylate | good |
| 10 | polymer 2 | ethlene glycol dimethacrylate | good |
| 11 | polymer 3 | triethlene glycol dimethacrylate | good |
| 12 | polymer 3 | 1,3-butanediol dimethacrylate | good |
| 13 | polymer 3 | 1,6-hexanediol dimethacrylate | good |
| 14 | polymer 3 | noepentyl glycol dimethacrylate | good |
| 15 | polymer 3 | tetraethylene glycol diacrylate | good |
| 16 | polymer 3 | nonaethylene glycol diacrylate | good |
| 17 | polymer 3 | 1,6-hexandiol diacrylate | good |
| 18 | polymer 3 | noepentyl glycol diacrylate | good |
| 19 | polymer 3 | Trimethylolpropane trimethacrylate | good |
| 20 | polymer 3 | Trimethylolpropane triacrylate | good |
| 21 | polymer 3 | Tetramethylolmethane tetraacrylate | good |
| 22 | polymer 3 | Dipentaerythritol hexaacrylate | good |
| 23 | polymer 3 | 9,9-bis(4-(2-acryloyloxyethoxy)phenyl)fluorene | good |

polymer 1: diallylorthophthalate prepolymer (Daiso DAP, Type K)
polymer 2: diallylisohthalate prepolymer (ISODAP)
polymer 3: diallylorthophthalate prepolymer (Daiso DAP, Type A)

### EXAMPLES 27 TO 36

(1) 2 g of diallylorthophthalate prepolymer (“Daiso DAP Type A” produced by Daiso Co., Ltd.), 3 g of a (meth)acrylate monomer shown in Table 3, 0.25 g of benzil, 0.085 g of Michler's ketone, and 3.5 g of acetone were mixed at an ordinary temperature to prepare recording material compositions comprising these components.

(2) The compositions were coated on one surface of a glass plate substrate having a dimension of 60×60×1.3 mm in an appropriate amount, and acetone was removed from the coated layer under reduced pressure, to produce recording materials having a two-layer structure comprising the substrate and the recording layer.

(3) A PET film in a strip form having a size of 1×60 mm and a thickness of 20 μm was placed on the recording layer, and a protective material comprising a glass plate having the same size as the substrate was placed thereon, to produce three-layer photosensitive plates having a sandwich form for recording a hologram.

(4) Interference was formed between object light and reference light by using a He—Cd laser. The three-layer photosensitive plate for recording a hologram was placed at a position, at which a fringe pattern formed by the interference could be caught. The photosensitive plate was exposed to He—Cd laser light (2.5 mW/cm²) for a prescribed period of time under the conditions, and an interference fringe to be a hologram could be recorded on the photosensitive plate.

The recording material compositions obtained in Examples 27 to 36 and results of measurement of diffraction efficiency conducted by using them are shown in Table 3.

Evaluation of Performance

The diffraction efficiency of each transmission type hologram obtained in the above-mentioned Examples 27-36 was calculated by determining a ratio of diffracted light to incident light with a light power meter (OPTICAL POWER/ENERGYMETER, MODEL 66XLA produced by PHOTODYNE Co., Ltd.) by the following equation.

Diffraction efficiency (%)=(diffracted light intensity/incident light intensity)×100

TABLE 3

| | | | | |
|---|---|---|---|---|
| EX- | | | | diffraction |
| AM- | | | exposure | efficiency |
| PLE | polymer | monomer | (mJ/cm | (%) |

| | | | | |
|---|---|---|---|---|
| 27 | polymer 3 | ethylene glycol dimethacrylate | 400 | 50 |
| 28 | polymer 3 | tetraethylene glycol | 250 | 92 |
| | | dimethacrylate | | |
| 29 | polymer 3 | nonaethylene glycol | 300 | 89 |
| | | dimethacrylate | | |
| 30 | polymer 3 | neopentyl glycol diacrylate | 300 | 90 |
| 31 | polymer 3 | nonaethylene glycol diacrylate | 175 | 83 |
| 32 | polymer 3 | trimethylolpropane | 400 | 56 |
| | | trimethacrylate | | |
| 33 | polymer 3 | trimethylolpropane triacrylate | 100 | 91 |
| 34 | polymer 3 | tetramethylolmethane triacrylate | 300 | 82 |
| 35 | polymer 3 | tetramethylolmethane | 40 | 81 |
| | | tetraacrylate | | |
| 36 | polymer 3 | dipentaerythritol hexaacrylate | 250 | 74 |

polymer 3: diallylorthoplithalate prepolymer (Daiso DAP, Type A)

### EXAMPLE 37

(1) 2 g of diallylorthophthalate prepolymer (“Daiso DAP Type A” produced by Daiso Co., Ltd.), 3 g of neopentyl glycol diacrylate (“NK Ester A-NPG” produced by Shin-Nakamura Chemical Co., Ltd.), 1.75 g of 3,3′4,4′-tetra(tert-butylperoxycarbonyl)benzophenone (“BTTB-25” produced by NOF Corporation) as a polymerization initiator, 0.005 g of 3,3′-carbonylbis(7-(diethylamino)coumarin) (“BC” produced by Midori Kagaku Co., Ltd.) as a photosensitizing dye, and 4 g of acetone were mixed at an ordinary temperature to prepare a recording material composition comprising these components.

(2) The composition was coated on one surface of a glass plate substrate having a dimension of 60×60×1.3 mm in an appropriate amount, and acetone was removed from the coated layer under reduced pressure, to produce a recording material having a two-layer structure comprising the substrate and the recording layer.

(3) A PET film in a strip form having a size of 1×60 mm and a thickness of 20 μm was placed on the recording layer, and a protective material comprising a glass plate having the same size as the substrate was placed thereon, to produce a three-layer photosensitive plate having a sandwich form for recording a hologram.

(4) Interference was formed between object light and reference light by using an Ar laser (wavelength: 488 nm). The three-layer photosensitive plate for recording a hologram was placed at a position, at which a fringe pattern formed by the interference could be caught. The photosensitive plate was exposed to Ar laser light (20 mW/cm²) for a prescribed period of time under the conditions, and an interference fringe to be a hologram could be recorded on the photosensitive plate.

The resulting hologram exhibited a diffraction efficiency of 89% at an exposed amount of 100 mJ/cm².

### EXAMPLE 38

(1) 2.3 g of diallylorthophthalate prepolymer (“Daiso DAP Type A” produced by Daiso Co., Ltd.), 1.8 g of 9,9-bis(4-(2-acryloyloxyethoxy)phenyl) fluorene (“BPEFA” produced by Osaka Gas Co., Ltd.), 0.9 g of vinyl bisphenylcarboxylate (produced by Nippon Steel Chemical Co., Ltd.), 1.75 g of 3,3′4,4′-tetra(tert-butylperoxycarbonyl)benzophenone (“BTTB -25” produced by NOF Corporation), 0.005 g of 3,3′-carbonylbis(7-(diethylamino)coumarin) (BC produced by Midori Kagaku Co., Ltd.), and 4 g of tetrahydrofuran were mixed at an ordinary temperature to prepare a recording material composition comprising these components.

(2) The composition was coated on one surface of a glass plate substrate having a dimension of 60×60×1.3 mm in an appropriate amount, and tetrahydrofuran was removed from the coated layer under reduced pressure, to produce a recording material having a two-layer structure comprising the substrate and the recording layer.

(3) A PET film in a strip form having a size of 1×60 mm and a thickness of 20 μm was placed on the recording layer, and a protective material comprising a glass plate having the same size as the substrate was placed thereon, to produce a three-layer photosensitive plate having a sandwich form for recording a hologram.

(4) Interference was formed between object light and reference light by using an At laser (wavelength: 488 nm). The three-layer photosensitive plate for recording a hologram was placed at a position, at which a fringe pattern formed by the interference could be caught. The photosensitive plate was exposed to Ar laser light (2 mW/cm²) for a prescribed period of time under the conditions, and an interference fringe to be a hologram could be recorded on the photosensitive plate.

The resulting hologram exhibited a diffraction efficiency of 47% at an exposed amount of 40 mJ/cm².

### EXAMPLE 39

(1) 2.3 g of triallylisocyanurate prepolymer (“TAIC Prepolymer” produced by Nippon Kasei Chemical Co., Ltd.), 2.7 g of neopentyl glycol diacrylate (“NK Ester A-NPG” produced by Shin-Nakamura Chemical Co., Ltd.), 1.75 g of 3,3′4,4′-tetra(tert-butylperoxycarbonyl)benzophenone (“BTTB-25” produced by NOF Corporation), 0.02 g of 3,3′-carbonylbis(7-(diethylamino)coumarin) (“BC” produced by Midori Kagaku Co., Ltd.), and 4 g of acetone were mixed at an ordinary temperature to prepare a recording material composition comprising these components.

(2) to (4) A photosensitive plate for recording a hologram was produced and a hologram was obtained by conducting the same procedures as in items (2) to (4) of Example 38.

The resulting hologram could be recorded with an exposure light amount of 50, 100 and 200 mJ/cm², and exhibited a diffraction efficiency of about 30%.

### EXAMPLE 40

(1) 5.5 g of diallylorthophthalate prepolymer (“Daiso DAP Type A” produced by Daiso Co., Ltd.) was dissolved in 27.5 ml of acetone. 0.41 g of a 0.1N HCl aqueous solution was dissolved in 4.5 g of phenyltrimethoxysilane that had been separately prepared, and the resulting solution was mixed with the acetone solution obtained above, followed by stirring at 20° C. for 1 hour. The resulting solution was heated in an oven with a temperature increasing rate of 10° C. per hour from 20 to 80° C., and was allowed to stand at 80° C. for 3 days, to remove the solvent, methanol as a by-product and water. As a result, a transparent uniform complex of a diallylphthalate and an inorganic substance was obtained as a reaction product.

(2) 2.5 g of the reaction product, 2.5 g of neopentyl glycol diacrylate (“NK Ester A-NPG” produced by Shin-Nakamura Chemical Co., Ltd.), 1.75 g of 3,3′4,4′-tetra(tert-butylperoxycarbonyl)benzophenone (“BTTB-25” produced by NOF Corporation), 0.005 g of 3,3′-carbonylbis(7-(diethylamino)coumarin) (“B C” produced by Midori Kagaku Co., Ltd.), and 4 g of acetone were mixed at an ordinary temperature to prepare a recording material composition comprising these components.

(3) to (5) A photosensitive plate for recording a hologram was produced and a hologram was obtained by conducting the same procedures as in items (2) to (4) of Example 38.

The resulting hologram could be recorded with an exposure light amount of 50, 100 and 150 mJ/cm², and exhibited a diffraction efficiency of about 30%.

### EXAMPLE 41

(1) 3 g of diallylorthophthalate prepolymer (“Daiso DAP Type A” produced by Daiso Co., Ltd.), 1 g of thiophenol (“TP” produced by Sumitomo Seika Chemicals Co., Ltd.), and 0.02 g of azobisisobutyronitrile as a catalyst were dissolved in 30 ml of acetone. The resulting solution was refluxed at 70° C. for 2 hours, and put in 200 g of methanol, in which 0.1 g of hydroquinone had been dissolved, to obtain an adduct of a diallylorthophthalate prepolymer and thiol, as a reaction product.

(2) 2.5 g of the reaction product, 2.5 g of neopentyl glycol diacrylate (“NK Ester A-NPG” produced by Shin-Nakamura Chemical Co., Ltd.), 1.75 g of 3,3′4,4′-tetra(tert-butylperoxycarbonyl)benzophenone (“BTTB-25” produced by NOF Corporation), 0.005 g of 3,3′-carbonylbis(7-(diethylamino)coumarin) (“BC” produced by Midori Kagaku Co., Ltd.), and 4 g of acetone were mixed at an ordinary temperature to prepare a recording material composition comprising these components.

(3) to (5) A photosensitive plate for recording a hologram was produced and a hologram was obtained by conducting the same procedures as in items (2) to (4) of Example 38.

The resulting hologram could be recorded with an exposure light amount of 50, 100 and 150 mJ/cm², and exhibited a diffraction efficiency of about 30%.

### EXAMPLE 42

(1) 10 g of diallylorthophthalate prepolymer (“Daiso DAP Type A” produced by Daiso Co., Ltd.) was dissolved in 300 ml of carbon tetrachloride. 30 ml of bromine was added dropwise to the solution over 1 hour with stirring at 5° C. or less. The resulting solution was put in 1,000 g of methanol, in which 0.1 g of hydroquinone had been dissolved, to obtain an adduct of a diallylorthophthalate prepolymer and bromine deposited as a reaction product.

(2) 2.5 g of the reaction product, 2.5 g of neopentyl glycol diacrylate (“NK Ester A-NPG” produced by Shin-Nakamura Chemical Co., Ltd.), 1.75 g of 3,3′4,4′-tetra(tert-butylperoxycarbonyl)benzophenone (“BTTB-25” produced by NOF Corporation), 0.005 g of 3,3′-carbonylbis(7-(diethylamino)coumarin) (“BC” produced by Midori Kagaku Co., Ltd.), and 4 g of acetone were mixed at an ordinary temperature to prepare a recording material composition comprising these components.

(3) to (5) A hologram was obtained by conducting the same procedures as in items (2) to (4) of Example 38.

The resulting hologram could be recorded with an exposure light amount of 50, 100 and 150 mJ/cm², and exhibited a diffraction efficiency of about 30%.

In Examples 27 to 42, no operation of development or fixing was necessary. Because the recording layer was sandwiched by the two glass plates, the thickness of the recording layer was uniform after exposure. There was no unevenness between a portion that had been irradiated with light of a high intensity and a portion that had been irradiated with light of a low intensity, and the record was formed with a refractive index modulation. A transparent hologram having a high brightness and substantially no absorption in the visible region was thus obtained. A stable image was maintained after removing the protective material.

### EXAMPLE 43

8.5 g of diallylorthophthalate prepolymer (“Daiso DAP Type A” produced by Daiso Co., Ltd.), 10 g of ethylene glycol dimethacrylate (“NK Ester 1G” produced by Shin-Nakamura Chemical Co., Ltd.), 1.5 g of polyarylate (“U-100” produced by Unitika Ltd.) as a solvent-soluble thermoplastic resin, 0.6 g of benzil as a polymerization initiator, 0.2 g of Michler's ketone as a photo-sensitizing dye and 20 g of dichloromethane were mixed at an ordinary temperature to prepare a recording material composition comprising these components.

(2) to (4) A photosensitive plate for recording a hologram was produced and a hologram was copied by conducting the same manner as in items (2) to (4) of Example 1.

A copy thus obtained suffered no coloring, and had a high brightness of diffraction efficiency of about 35% conducting development and fixing.

### EXAMPLE 44

The same procedures as in Example 43 were repeated, except that 1.5 g of polysulfone (“Udel P-1700” produced by Amoco Polymers Inc.) as solvent-soluble thermoplastic resin was used, to produce recording material composition and a photosensitive plate for recording hologram on which a hologram was copied.

A copy thus obtained suffered no coloring, and had a high brightness of diffraction efficiency of about 35% conducting development and fixing.

### EXAMPLE 45

(1) 5 g of diallyl orthophthalate prepolymer (“Daiso DAP, DAPA” produced by Daiso Co., Ltd.) as an allyl-based prepolymer (A), 1 g of an acrylic acid adduct of 9,9-bis(4-hydroxyphenyl)fluorene glycidyl ether (“ASF400” produced by Nippon Steel Chemical Co., Ltd.) as a radical polymerizable compound (b1), 3.5 g of 3,3′,4,4′-tetra(tert-butylperoxycarbonyl)benzophenone (“BTTB-25” produced by NOF Corporation) as a photopolymerization initiator, 0.01 g of a merocyanine-based dye (“NK4795” produced by Nippon Photosensitizing Dye Co., Ltd.) as a sensitizing dye, 4 g of diethyl sebacate (“SDE” produced by Wako Pure Chemical Co., Ltd.) as a viscosity reducing agent (e1) and 6 g of acetone as a solvent were mixed at an ordinary temperature to prepare a recording material composition.

(2) The composition was coated on one surface of a glass plate substrate having a dimension of 60 mm×60 mm to a thickness of 20 μm after drying. The solvent was removed from the coated layer under reduced pressure, to produce a recording medium having a two-layer structure comprising the substrate and the recording layer.

(3) The same glass plate as mentioned above was placed to cover the recording layer of this recording medium, to produce a three-layer photosensitive plate for recording a hologram.

(4) An Ar ion laser of 488 nm was split with a beam splitter, angles of each light were changed with a reflector, and both were recomposed to form interference to obtain an interference fringe. The photosensitive plate was placed at a position where this interference fringe could be caught.

(5) FIGS. 1 and 2 show examples of a transmission type hologram and a reflection type hologram respectively. In the figures, (1) is the photosensitive plate, and (2) is laser light.

(6) The photosensitive plate was exposed to light under the conditions, and the interference fringe to be the hologram was recorded on the photosensitive plate.

This exposure to light of the transmission type hologram and the reflection type hologram was carried out using a light intensity on the photosensitive plate of 1.0 mW/cm² for 10 to 100 seconds at an exposed amount of 1 to 100 mJ/cm².

### EXAMPLES 46 TO 49

The same procedures as in Example 45 were repeated to produce three-layer photosensitive plates for recording a hologram, except that the allyl-based prepolymer (A), the radical polymerizable compound (b1) and the viscosity reducing agent (E) were used in the amounts shown in Table 4. Holograms were recorded by using these photosensitive plates.

### EXAMPLES 50 AND 51

The same procedures as in Example 45 were repeated to produce three-layer photosensitive plates for recording a hologram, except that diallyl isophthalate prepolymer (“Daiso ISO-DAP, DAIP” produced by Daiso Co., Ltd.) or triallyl isocyanurate prepolymer (“TAIC Prepolymer, TAIC” produced by Nippon Kasei Chemical Co., Ltd.) as the allyl-based prepolymer (A), bisphenoxyethanolfluorene diacrylate (“BPEFA” produced by Osaka Gas Co., Ltd.) as the radical polymerizable compound (b1) and SDE as the viscosity reducing agent (E) were used in respective amounts shown in Table 4. Holograms were recorded by using these photosensitive plates.

### EXAMPLES 52 AND 53

The same procedures as in Example 45 were repeated to produce three-layer photosensitive plates for recording a hologram, except that ASF400 as the radical polymerizable compound (b1) and divinylbiphenyl (“DBVP” produced by Nippon Steel Chemical Co., Ltd.) as a radical polymerizable compound (b2) were used in respective amounts shown in Table 4. Holograms were recorded by using these photosensitive plates.

### EXAMPLES 54 TO 61

The same procedures as in Example 45 were repeated to produce three-layer photosensitive plates for recording a hologram, except that ASF400, bis(4-methacryloylthiophenyl)sulfide (“MPSMA” produced by Sumitomo Seika Chemicals Co., Ltd.), tribromophenol acrylate (“BR-30” produced by Daiichi Kogyo Pharmaceutical Co., Ltd.), tribromophenol methacrylate (“SR-804” produced by Daiichi Kogyo Pharmaceutical Co., Ltd.) or N-vinylcarbazole (“NVC” produced by Tokyo Chemical Industry Co., Ltd.) as the radical polymerizable compound (b1), DBVP as the radical polymerizable compound (b2) and SDE as a nonreactive viscosity reducing agent (e1) were used in respective amounts shown in Table 4. Holograms were recorded by using these photosensitive plates.

### EXAMPLES 62 TO 71

The same procedures as in Example 45 were repeated to produce three-layer photosensitive plates for recording a hologram, except that ASF400 as the radical polymerizable compound (b1), diethyl adipate (“ADE” produced by Kanto Chemical Industry Co., Ltd.), dibutyl adipate (“ADB” produced by Wako Pure Chemical Co., Ltd.), dibutyl sebacate (“SDB” produced by Wako Pure Chemical Co., Ltd.), dimethyl phthalate (“PDM” produced by Wako Pure Chemical Co., Ltd.), dibutyl phthalate (“PDB” produced by Kanto Chemical Industry Co., Ltd.) or dioctyl phthalate (“PDO” produced by Wako Pure Chemical Co., Ltd.) instead of SDE as the nonreactive viscosity reducing agent (e1), diallyl orthophthalate monomer (“DAPM” produced by Daiso Co., Ltd.), diallyl isophthalate monomer (“DAIM” produced by Daiso Co., Ltd.), diallyl terephthalate monomer (“DATM” produced by Daiso Co., Ltd.) or diallyl adipate (“ADA ” produced by Tokyo Chemical Industry Co., Ltd.) as a (meth)allyl-based viscosity reducing agent (e2) were used in respective amounts shown in Table 5. Holograms were recorded by using these photosensitive plates.

### Comparative Examples 1 to 5

Almost the same procedures as in Example 1 were repeated to produce three-layer photosensitive plates for recording a hologram, except that ASF400, MPSMA, BP-30, SR-804, NVC or DBVP as the radical polymerizable compound was used in the amount shown in Table 6 and the viscosity reducing agent was not used. Holograms were recorded by using these photosensitive plates. All these radical polymerizable compounds have refractive indexes higher than that of the allyl-based prepolymer (A).

Evaluations of obtained measured values are shown in Tables 4 to 7.

All the holograms obtained in Examples suffered no coloring, and had a high brightness of a diffraction efficiency of 30% or more for the transmission type hologram and the reflection type hologram without conducting development and fixing. The holograms maintained a stable image for a long period of three months or more, after peeling the glass plate. The records were formed with the refractive index modulation, but not unevenness on the recording layer, and transparent holograms having substantially no absorption in the visible region were obtained.

On the other hand, all the holograms obtained in Comparative Examples exhibited only a diffraction efficiency of less than 10%.

Evaluation of Performance

The diffraction efficiency of each transmission type hologram obtained in the above-mentioned Examples 45-71 and Comparative Examples 1-5 was calculated by determining a ratio of diffracted light to incident light with a light power meter (OPTICAL POWER/ENERGYMETER, MODEL 66XLA produced by PHOTODYNE Co., Ltd.) by the following equation.

Diffraction efficiency (%)=(diffracted light intensity/incident light intensity)×100

The diffraction efficiency of the reflection type hologram was determined by measuring transmittance with an ultraviolet spectrophotometer (“V-550” produced by Nippon Spectroscopy Co., Ltd.).

The obtained results in the above-mentioned Examples 45-71 and Comparative Examples 1-5 are shown by Tables 4 to 6.

TABLE 4

| | Example | | | | | | | | | | | | | | | | |
|---|---|---|---|---|---|---|---|---|---|---|---|---|---|---|---|---|---|
| | 45 | 46 | 47 | 48 | 49 | 50 | 51 | 52 | 53 | 54 | 55 | 56 | 57 | 58 | 59 | 60 | 61 |
| Allyl-based prepolymer (A) | | | | | | | | | | | | | | | | | |
| DAPA | 5 | 5 | 5 | 3 | 7.5 | | | 5 | 5 | 5 | 5 | 5 | 5 | 5 | 5 | 5 | 5 |
| DAIP | | | | | | 5 | | | | | | | | | | | |
| TAIC | | | | | | | 5 | | | | | | | | | | |
| Radical polymerizable | | | | | | | | | | | | | | | | | |
| compound (b1) | | | | | | | | | | | | | | | | | |
| ASF400 | 1 | 3 | 4 | 5 | 1.5 | | | 0.5 | 3 | | | | | | | 0.5 | 0.5 |
| BPEFA | | | | | | 2.5 | 2.5 | | | | | | | | | | |
| MPSMA | | | | | | | | | | 2 | | | | 2 | | 0.5 | 0.5 |
| BR-30 | | | | | | | | | | | 2 | | | | 2 | 0.5 | 0.5 |
| SR-804 | | | | | | | | | | | | 2 | | | | 0.5 | |
| NVC | | | | | | | | | | | | | 2 | | | 0.5 | |
| Radical polymerizable | | | | | | | | | | | | | | | | | |
| compound (b2) | | | | | | | | | | | | | | | | | |
| DBVP | | | | | | | | 3 | 0.5 | | | | | 1.5 | 1.5 | | 1.5 |
| Nonreactive viscosity | | | | | | | | | | | | | | | | | |
| reducing agent (e1) | | | | | | | | | | | | | | | | | |
| SDE | 4 | 2 | 1 | 2 | 1 | 2.5 | 2.5 | 1.5 | 1.5 | 3 | 3 | 3 | 3 | 1.5 | 1.5 | 2.5 | 2 |
| Polymerization initiator | | | | | | | | | | | | | | | | | |
| BTTB-25 | 3.5 | 3.5 | 3.5 | 3.5 | 3.5 | 3.5 | 3.5 | 3.5 | 3.5 | 3.5 | 3.5 | 3.5 | 3.5 | 3.5 | 3.5 | 3.5 | 3.5 |
| Dye | | | | | | | | | | | | | | | | | |
| NK4795 | 0.01 | 0.01 | 0.01 | 0.01 | 0.01 | 0.01 | 0.01 | 0.01 | 0.01 | 0.01 | 0.01 | 0.01 | 0.01 | 0.01 | 0.01 | 0.01 | 0.01 |
| Solvent | | | | | | | | | | | | | | | | | |
| Acetone | 6 | 6 | 6 | 6 | 6 | 6 | 6 | 6 | 6 | 6 | 6 | 6 | 6 | 6 | 6 | 6 | 6 |
| Diffraction efficiency (%) | ◯ | ◯ | ◯ | ◯ | ◯ | ◯ | ◯ | ◯ | ◯ | ◯ | ◯ | ◯ | ◯ | ◯ | ◯ | ◯ | ◯ |
| transmission type | | | | | | | | | | | | | | | | | |
| Diffraction efficiency (%) | ◯ | ◯ | ◯ | ◯ | ◯ | ◯ | ◯ | ◯ | ◯ | ◯ | ◯ | ◯ | ◯ | ◯ | ◯ | ◯ | ◯ |
| reflection type | | | | | | | | | | | | | | | | | |

X: less than 10%
◯: 30% or more

TABLE 5

| | Example | | | | | | | | | |
|---|---|---|---|---|---|---|---|---|---|---|
| | 62 | 63 | 64 | 65 | 66 | 67 | 68 | 69 | 70 | 71 |
| Allyl + based | | | | | | | | | | |
| prepolymer (A) | | | | | | | | | | |
| DAPA | 5 | 5 | 5 | 5 | 5 | 5 | 5 | 5 | 5 | 5 |
| Radical polymerizable | | | | | | | | | | |
| compound (b1) | | | | | | | | | | |
| ASF400 | 2.5 | 2.5 | 2.5 | 2.5 | 2.5 | 2.5 | 2.5 | 2.5 | 2.5 | 2.5 |
| Radical polymerizable | | | | | | | | | | |
| compound (b2) | | | | | | | | | | |
| DBVP | | | | | | | | | | |
| Nonreactve viscosity | | | | | | | | | | |
| reducing agent (e1) | | | | | | | | | | |
| ADE | 2.5 | | | | | | | | | |
| ADB | | 2.5 | | | | | | | | |
| SDB | | | 2.5 | | | | | | | |
| PDM | | | | 2.5 | | | | | | |
| PDB | | | | | 2.5 | | | | | |
| PDO | | | | | | 2.5 | | | | |
| (Meth)allyl-based viscosity | | | | | | | | | | |
| reducing agent (e2) | | | | | | | | | | |
| DAPM | | | | | | | 2.5 | | | |
| DAIM | | | | | | | | 2.5 | | |
| DATM | | | | | | | | | 2.5 | |
| ADA | | | | | | | | | | 2.5 |
| Polymerization initiator | | | | | | | | | | |
| BTTB-25 | 3.5 | 3.5 | 3.5 | 3.5 | 3.5 | 3.5 | 3.5 | 3.5 | 3.5 | 3.5 |
| Dye | | | | | | | | | | |
| NK4795 | 0.01 | 0.01 | 0.01 | 0.01 | 0.01 | 0.01 | 0.01 | 0.01 | 0.01 | 0.01 |
| Solvent | | | | | | | | | | |
| Acetone | 6 | 6 | 6 | 6 | 6 | 6 | 6 | 6 | 6 | 6 |
| Diffracfion efficiency (%) | ◯ | ◯ | ◯ | ◯ | ◯ | ◯ | ◯ | ◯ | ◯ | ◯ |
| transmission type | | | | | | | | | | |
| Diffraction efficiency (%) | ◯ | ◯ | ◯ | ◯ | ◯ | ◯ | ◯ | ◯ | ◯ | ◯ |
| reflection type | | | | | | | | | | |

X: less than 10%
◯: 30% or more

TABLE 6

| | Comparative Example | | | | |
|---|---|---|---|---|---|
| | 1 | 2 | 3 | 4 | 5 |
| Allyl-based prepolymer (A) | | | | | |
| DAPA | 5 | 5 | 5 | 5 | 5 |
| Radical polymerizable | | | | | |
| compound (b1) | | | | | |
| ASF400 | 4 | | | | |
| MPSMA | | 4 | | | |
| BR-30 | | | 5 | | |
| SR-804 | | | | 5 | |
| NVC | | | | | 5 |
| Radical polymerizable | | | | | |
| compound (b2) | | | | | |
| DBVP | 1 | 1 | | | |
| Polymerization initiator | | | | | |
| BTTB-25 | 3.5 | 3.5 | 3.5 | 3.5 | 3.5 |
| Dye | | | | | |
| NK4795 | 0.01 | 0.01 | 0.01 | 0.01 | 0.01 |
| Solvent | | | | | |
| Acetone | 6 | 6 | 6 | 6 | 6 |
| Diffraction efficiency (%) | X | X | X | X | X |
| transmission type | | | | | |
| Diffraction efficiency (%) | X | X | X | X | X |
| reflection type | | | | | |

X: less than 10%
◯: 30% or more

Because the hologram recording material composition of the invention is substantially in a solid state, a heat treatment for solidifying a flowable composition, as a conventional product, is not necessary. Therefore, the composition of the invention can simplify the film formation operation on producing a hologram recording medium, and thus exhibits good workability.

Because the recording layer obtained from the hologram recording material composition of the invention is substantially in a solid state, it is excellent in handling as when touched with hand, it does not contaminate hand. Additionally, in the recording material having the recording layer, the recording layer suffers no drip or shift from the substrate when it is slanted, and it is thus easy to transport.

Furthermore, the recording material after recording a hologram has a high transparency and is excellent in stability because the allyl-based prepolymer (A) and the (meth)acrylate-based compound (B) are present in the form of a polymer having a sufficient high molecular weight, and it is free of a problem in that a record becomes unclear due to re-diffusion of them. Therefore, an operation of development or fixing for stabilizing the recorded image is not necessary, and thus a hologram can be recorded by a real-time operation.

Furthermore, when the radical polymerizable compound (b1) of which typical example is the fluorene-based compound, and the viscosity reducing agent (E) are used simultaneously, a reflection type hologram can also be recorded with a high diffraction efficiency, while maintaining the above-mentioned characteristics.

According to the invention, a hologram recording material composition can be provided that can eliminate complication in film forming operation, which is the problems associated with the conventional product, while exhibiting good performance demanded for a hologram, such as a transparency, a diffraction efficiency and a resolution, as similar to the conventional product.

Furthermore, the recording material after recording the hologram has the high transparency. Since the allyl-based prepolymer (A) and the (meth)acrylate-based compound (B) are present in the form of the polymer having the sufficient high molecular weight by only one exposure to light, it is free of the problem in that the record becomes unclear due to the re-diffusion of them. The recording material is also excellent in long-term heat resistance, weather resistance, solvent resistance and the like. Therefore, the operation of development or fixing for stabilizing the recorded image is not necessary, and thus the hologram can be recorded by the real-time operation.

What is claimed is:

1. A non-aqueous solvent-soluble hologram recording material composition comprising (A) an allyl-based prepolymer being soluble in a non-aqueous solvent and having at least one allyl group in a molecule thereof and a molecular weight of 10,000 to 100,000, (B) a (meth)acrylate-based compound having at least one polymerizable unsaturated group in a molecule thereof, and (C) a photo-polymerization initiator, wherein a difference between a refractive index of said allyl-based prepolymer (A) and a refractive index of a polymer of said (meth)acrylate compound (B) is 0.005 or more.

2. A hologram recording material composition as claimed in claim 1, wherein said composition further comprises (D) a solvent-soluble thermoplastic resin in a weight ratio to said allyl-based prepolymer (A),(A):(D) of 80 to 100:20 to 0.

3. A hologram recording material composition as claimed in claim 1, wherein said allyl-based prepolymer (A) is a homopolymer of an allyl-based monomer having at least two allyl groups in a molecule thereof or a copolymer of said allyl-based monomer and another copolymerizable monomer, the copolymer containing a polymeric unit of said allyl-based monomer in an amount of more than 20% (excluding 20%).

4. A hologram recording material composition as claimed in claim 3, wherein said allyl-based monomer is a diallylphthalate-based monomer.

5. A hologram recording material composition as claimed in claim 1, wherein said allyl-based prepolymer (A) is an organic-inorganic complex transparent uniform material obtained by subjecting a metallic alkoxide having a metallic atom, a group having an aromatic ring, and a hydrolyzable group to dehydration condensation by a sol-gel method in the presence of a diallyl phthalate-based monomer and/or a diallyl phthalate-based polymer.

6. A hologram recording material composition as claimed in claim 1, wherein said allyl-based prepolymer (A) has a thioether group and/or a halogen atom connected to a main chain thereof.

7. A hologram recording material composition as claimed in claim 1, wherein said allyl-based prepolymer (A) is a diallylphthalate-based prepolymer.

8. A hologram recording material composition as claimed in claim 7, wherein said diallylphthalate-based prepolymer is a prepolymer selected from the group consisting of a diallylorthophthalate prepolymer, a diallylisophthalate prepolymer and a diallylterephthalate prepolymer, or a combination of two or more thereof.

9. A hologram recording material composition as claimed in claim 1, wherein said (meth)acrylate-based compound (B) contains from 1 to 6 of polymerizable unsaturated group, and has a molecular weight of 2,000 or less.

10. A hologram recording material composition as claimed in claim 1, wherein said (meth)acrylate-based compound (B) contains two of polymerizable unsaturated group.

11. A hologram recording material composition as claimed in claim 1, wherein said composition further comprises a viscosity reducing agent (E) and said (meth)acrylate-based compound (B) contains at least one radical polymerizable compound (b1) selected from the group consisting of a fluorene-based compound represented by the general formula [I], 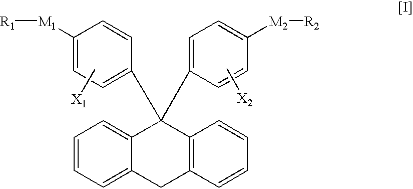
wherein
R₁ and R₂, being the same or different, are monovalent organic groups, at least one of which has a radical polymerizable group at its terminal, M₁ and M₂, being the same or different, are divalent organic groups represented by —(OR)ₙ₁— (wherein R is lower alkylene which can have hydroxyl and/or oxygen, and n1 is 0 or an integer of 1 to 5) or single bonds, and X₁ and X₂, being the same or different, are substituents of the rings and are halogen, hydroxyl or lower alkyl,
a sulfide-based cyclic compound represented by the general formula [II], 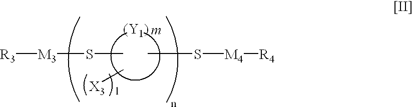
wherein
R₃ and R₄, being the same or different, are monovalent organic groups, at least one of which has a radical polymerizable group at its terminal, M₃ and M₄, being the same or different, are divalent organic groups represented by —(OR)ₙ₂— (wherein R is lower alkylene which can have hydroxyl and/or oxygen, and n2 is 0 or an integer of 1 to 5) or single bonds, X₃ is a substituent of the ring and is halogen, hydroxyl or lower alkyl, “l” is an X₃ number of 0 to 6, Y₁ is a ring member atom constituting the ring, all of the atoms (Y₁)ₘ are carbon atoms, or a portion of them is carbon atom(s) and the rest atoms are heteroatoms, and “m” is a member number of the ring of 5 to 8,
a halogenated cyclic compound represented by the general formula [III], 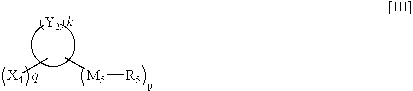
wherein
X₄ is a substituent of the ring, at least one of plural (X₄)_{q} is halogen and others are hydroxyl or lower alkyl, “q” is an integer of 2 to 6, R₅ is a monovalent organic group, at least one of plural (R₅ )ₚ has a radical polymerizable group at its terminal, M₅ is a divalent organic group represented by —(ORₙ₃— (wherein R is lower alkylene which can have hydroxyl and/or oxygen, and n3 is 0 or an integer of 1 to 5) or a single bond, “p” is an integer of 1 to 4, Y₂ is a ring member atom constituting the ring, all of the atoms (Y₂)ₖ are carbon atoms, or a portion of them is carbon atom(s) and the rest atoms are heteroatoms, and “k” is a member number of the ring of 5 to 8, and
a carbazole-based compound represented by the general formula [IV], 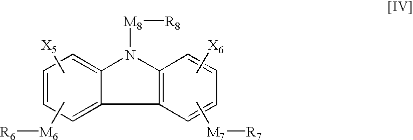
wherein
R₆, R₇ and R₈, being the same or different, are monovalent organic groups, at least one of which has a radical polymerizable group at its terminal, M₆, M₇ and M₈, being the same or different, are divalent organic groups represented by —(OR)ₙ₄— (wherein R is lower alkylene which can have hydroxyl and/or oxygen, and n4 is 0 or an integer of 1 to 5) or single bonds, and X₅ and X₆, being the same or different, are substituents of the ring and are halogen, hydroxyl or lower alkyl.

12. A hologram recording material composition as claimed in claim 11, wherein a weight ratio of at least one radical polymerizable compound (b1) selected from the group consisting of a fluorene-based compound [I], a sulfide-based cyclic compound [II], a halogenated cyclic compound [III] and a carbazole-based compound [IV] to at least one radical polymerizable compound (b2) selected from the group consisting of the other radical polymerizable compounds than the fluorene-based compound [I], the sulfide-based cyclic compound [II], the halogenated cyclic compound [III] and the carbazole-based compound [IV], (b1):(b2) is 10 to 100:0 to 90 in said (meth)acrylate-based compound (B).

13. A hologram recording material composition as claimed in claim 2, wherein said solvent-soluble thermoplastic resin (D) has a refractive index of 1.300 to 1.800.

14. A hologram recording material composition as claimed in claim 2, wherein said solvent-soluble thermoplastic resin (D) is one or a combination of two or more selected from the group consisting of a condensation polymerization product of a diphenol compound and a dicarboxylic acid compound, a resin having a carbonate group in a molecule thereof, a resin having an —SO₂— group in a molecule thereof, polyvinylidene chloride, and a homopolymer or copolymer obtained by polymerizing at least one monomer having an ethylenic unsaturated double bond.

15. A hologram recording material composition as claimed in claim 11, wherein said viscosity reducing agent (E) is a compound (e1) which in nonreactive on said allyl-based prepolymer (A) and said (meth)acrylate-based compound (B) or a compound (e2) having allyl or methallyl in a molecule thereof.

16. A hologram recording medium comprising a substrate having formed thereon a recording layer comprising a hologram recording material composition claimed in claim 1.

17. A non-aqueous solvent-based hologram recording material composition comprising (A) an allyl-based prepolymer having at least one allyl group in a molecule thereof and a molecular weight of 10,000 to 100,000, (B) a (meth)acrylate-based compound having at least one polymerizable unsaturated group in a molecule thereof, (C) a photo-polymerization initiator, and a non-aqueous solvent, wherein a difference between a refractive index of said allyl-based prepolymer (A) and a refractive index of a polymer of said (meth)acrylate compound (B) is 0.005 or more.
